(19) United States
(12) Patent Application Publication
(10) Pub. No.: US 2026/0059501 A1
(43) Pub. Date: Feb. 26, 2026

(54) METHOD, DEVICE AND COMPUTER STORAGE MEDIUM OF COMMUNICATION

(71) Applicant: NEC Corporation, Tokyo (JP)

(72) Inventors: Xiaohong ZHANG, Beijing (CN); Gang WANG, Beijing (CN)

(73) Assignee: NEC Corporation, Tokyo (JP)

(21) Appl. No.: 18/877,589

(22) PCT Filed: Jun. 24, 2022
(86) PCT No.: PCT/CN2022/101304

§ 371 Date: Dec. 20, 2024

(51) Int. Cl. H04W 72/0446; H04L 5/14

(52) U.S. Cl. CPC H04W 72/0446; H04L 5/14

(57) ABSTRACT

Embodiments of the present disclosure relate to methods, devices and computer readable media of communication. A terminal device receives, from a network device, an indication of a set of transmissions to be transmitted or received by the terminal device in a set of time intervals, a transmission in the set of transmissions being indicated to be transmitted or received by the terminal device in a time interval in the set of time intervals. If the time interval comprises a time interval associated with sub-band full duplex mode, the terminal device performs an operation related to transmitting or receiving the transmission. In this way, a sub-band non-overlapping full duplex scheme with respect to resource allocation may be well supported.

### TECHNICAL FIELD

Embodiments of the present disclosure generally relate to the field of telecommunication, and in particular, to methods, devices and computer storage media of communication.

### BACKGROUND

Traditionally, user equipment (UE) only performs a half duplex operation in a communication with a network. That is, if a half duplex time division duplex (TDD) mode is configured for a UE, the UE is only configured to perform one of an uplink (UL) transmission and a downlink (DL) transmission with a network for a bandwidth part (BWP) at one time.

In New radio (NR) technology, it is intended to deploy a sub-band non-overlapping full duplex scheme in an unpaired spectrum. That is, a UE may be configured with a symbol/slot with both DL resources and UL resources simultaneously, and a network device (for example, a gNB) may schedule DL transmissions for some UEs and UL transmissions for other UEs in the same symbol/slot. However, details of such a scheme are still incomplete and need to be further developed.

### SUMMARY

In general, embodiments of the present disclosure provide methods, devices and computer storage media of communication for a sub-band non-overlapping full duplex scheme.

In a first aspect, there is provided a method of communication. The method comprises: receiving, at a terminal device from a network device, an indication of a set of transmissions to be transmitted or received by the terminal device in a set of time intervals, a transmission in the set of transmissions being indicated to be transmitted or received by the terminal device in a time interval in the set of time intervals; and in response to determining that the time interval comprises a time interval associated with sub-band full duplex mode, performing an operation related to transmitting or receiving the transmission.

In a second aspect, there is provided a method of communication. The method comprises: receiving, at a terminal device from a network device, a first indication of a downlink transmission to be received by the terminal device in a downlink sub-band in a time interval associated with sub-band full duplex mode: receiving, from the network device, a second indication of a first uplink transmission to be transmitted by the terminal device in an uplink sub-band in the time interval associated with sub-band full duplex mode; and in response to determining that the downlink transmission is overlapped with the first uplink transmission in a time domain, performing an operation related to the downlink transmission or the first uplink transmission.

In a third aspect, there is provided a method of communication. The method comprises: transmitting, at a network device to a terminal device, an indication of a set of transmissions to be transmitted or received by the terminal device in a set of time intervals, a transmission in the set of transmissions being indicated to be transmitted or received by the terminal device in a time interval in the set of time intervals; and in response to the time interval comprising a time interval associated with sub-band full duplex mode, performing an operation related to receiving or transmitting the transmission by the network device.

In a fourth aspect, there is provided method of communication. The method comprises: transmitting, at a network device to a terminal device, a first indication of a downlink transmission to be received by the terminal device in a downlink sub-band in a time interval associated with sub-band full duplex mode: transmitting, to the terminal device, a second indication of a first uplink transmission to be transmitted by the terminal device in an uplink sub-band in the time interval associated with sub-band full duplex mode; and in response to the downlink transmission being overlapped with the first uplink transmission in time domain, performing an operation related to the downlink transmission or the first uplink transmission.

In a fifth aspect, there is provided a terminal device. The terminal device comprises a processor and a memory coupled to the processor and storing instructions thereon. The instructions, when executed by the processor, cause the terminal device to perform the method according to the first or second aspect of the present disclosure.

In a sixth aspect, there is provided a network device. The network device comprises a processor and a memory coupled to the processor and storing instructions thereon. The instructions, when executed by the processor, cause the network device to perform the method according to the third or fourth aspect of the present disclosure.

In a seventh aspect, there is provided a computer readable medium having instructions stored thereon. The instructions, when executed on at least one processor, cause the at least one processor to perform the method according to the first or second aspect of the present disclosure or the method according to the third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates a schematic diagram of an example communication network in which some embodiments of the present disclosure can be implemented;

FIG. 2 illustrates a schematic diagram illustrating an example scenario of multiple transmissions in SBFD communication in a related solution:

FIG. 3 illustrates a schematic diagram illustrating a process of communication for multiple transmissions in SBFD communication according to embodiments of the present disclosure:

FIGS. 4A-4E illustrate schematic diagrams illustrating example scenarios of multiple transmissions in SBFD communication according to embodiments of the present disclosure:

FIGS. 5A-5C illustrate schematic diagrams illustrating example scenarios of transmissions with frequency hopping in SBFD communication according to embodiments of the present disclosure:

FIG. 6 illustrates a schematic diagram illustrating a process of communication for DL transmission and UL transmission in SBFD communication according to embodiments of the present disclosure:

FIGS. 7A-7D illustrate schematic diagrams illustrating example scenarios of UL transmission and DL transmission in SBFD communication according to embodiments of the present disclosure:

FIG. 8 illustrates an example method of communication implemented at a terminal device in accordance with some embodiments of the present disclosure:

FIG. 9 illustrates another example method of communication implemented at a terminal device in accordance with some embodiments of the present disclosure:

FIG. 10 illustrates an example method of communication implemented at a network device in accordance with some embodiments of the present disclosure:

FIG. 11 illustrates another example method of communication implemented at a network device in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “occasion” refers to any of the following: 1) a time domain resource and frequency domain resource assigned, configured or granted for a data transmission, for example, the time domain resource may include one or more slots, one or more mini-slots, or one or more symbols: 2) one or more slots in which a DL assignment, UL grant or sidelink grant occurs: 3) one or more symbols in which a DL assignment, UL grant or sidelink grant occurs.

In the context of the present application, the term “SBFD symbol/slot” refers to a symbol/slot with sub-bands that a network device (for example, a gNB) would use for SBFD operation. For SBFD operation within a TDD carrier, a SBFD sub-band consists of 1 resource block (RB) or a set of consecutive RBs for the same transmission direction. In the context of the present application, the term “SBFD capable UE” refers to UE that is aware of the time and frequency domain location of SBFD sub-band.

In the context of the present application, the term “symbol” refers to an orthogonal frequency division multiplexing (OFDM) symbol or a discrete Fourier transform spread OFDM (DFT-s-OFDM) symbol. The term “slot” includes multiple consecutive symbols, e.g., 14 symbols, or 12 symbols. The term “mini-slot” includes one or more consecutive symbols, and has less symbol than a slot, e.g., 1, 2, 4, or 7 symbols.

Generally, in a traditional half duplex TDD mode, a symbol/slot in a TDD carrier can only be used for DL transmissions or UL transmissions. A UE determines the dynamic scheduled transmission or higher layer configuration in a symbol/slot based on the TDD configuration of the carrier, e.g., configured by tdd-UL-DL-ConfigurationCommon and/or by tdd-UL-DL-ConfigurationDedicated. In other words, a symbol/slot on a cell is only associated with one transmission direction (for example, DL or UL). A symbol/slot associated with one transmission direction is called as a half duplex symbol/slot, i.e., TDD symbol/slot. For example, a DL symbol/slot is only associated with DL transmission direction: an UL symbol/slot is only associated with UL transmission direction; and a flexible symbol/slot is DL or UL transmission direction. In TDD mode, a network device (for example, a gNB) may only schedule DL transmissions for UEs in the cell on DL symbols/slots and/or flexible symbols/slots and only schedule UL transmissions for UEs in the cell on UL symbols/slots and/or flexible symbols/slots.

However, in a sub-band non-overlapping full duplex scheme, to improve more opportunities for UL transmission for latency reduction and coverage improvement, simultaneous UL reception and DL transmission on a SBFD symbol/slot on a TDD carrier is supported for a network device (for example, a gNB) while a UE still works on half duplex mode. Under this scheme, a BWP may be divided into multiple non-overlapping sub-bands. A guard band may be configured between two sub-bands in a BWP. A UE may be configured to perform an UL transmission over one of the multiple sub-bands in a symbol/slot and perform a DL transmission over another of the multiple sub-bands in another symbol/slot. That is, a UE may perform transmission or reception in a sub-band full duplex mode. This scheme may achieve enhanced UL coverage, reduced latency, improved system capacity and improved configuration flexibility for NR TDD operations in an unpaired spectrum.

One possible sub-band non-overlapping full duplex scheme is that UL sub-band for UL transmission is on DL symbol or flexible symbol configured by tdd-UL-DL-ConfigurationCommon and or tdd-UL-DL-ConfigurationDedicated. When a sub-band non-overlapping full duplex scheme is deployed in an unpaired spectrum, a symbol/slot on a cell may be associated with one transmission direction (i.e., DL or UL) or two transmission directions (i.e., DL and UL). A symbol/slot associated with two transmission directions is called as a sub-band full duplex (SBFD) symbol/slot. The network device may schedule DL transmissions for UEs in the cell on DL TDD symbols/slots, flexible TDD symbols/slots and SBFD symbols/slots and may schedule UL transmissions for UEs in the cell on UL TDD symbols/slots, flexible TDD symbols/slots and SBFD symbols/slots.

The SBFD scheme may have impact on both DL transmissions and UL transmissions. Therefore, details as to how to handle DL transmissions or UL transmissions in the SBFD scheme may need to be further developed or improved. For example, in case a higher layer configured transmission cross TDD symbols/slots (e.g., UL TDD symbols/slots and flexible TDD symbols/slots for UL transmission; and DL TDD symbols/slots and flexible TDD symbols/slots for DL transmission) and SBFD symbols/slots, how to handle the transmission with variable frequency domain resources is not clear.

In view of this, embodiments of the present disclosure provide a solution for solving the above and other potential issues. Principles and implementations of the present disclosure will be described in detail below with reference to the figures.

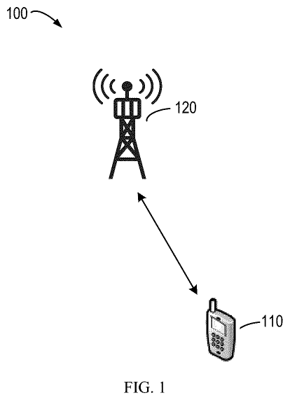

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the network device 120 may provide a serving cell (also referred to as a cell herein), and the terminal device 110 may be located in the cell and may be served by the network device 120. It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 is referred to as UL communication, while communication in a reverse direction from the network device 120 towards the terminal device 110 is referred to as DL communication. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH), and a physical broadcast channel (PBCH).

In some embodiments, the terminal device 110 may transmit UL data to the network device 120 via a UL data channel transmission. For example, the UL data channel transmission may be a physical uplink shared channel (PUSCH) transmission. Of course, any other suitable forms are also feasible.

In some embodiments, the terminal device 110 may receive DL data from the network device 120 via a DL data channel transmission. For example, the DL data channel transmission may be a physical downlink shared channel (PDSCH) transmission. Of course, any other suitable forms are also feasible.

In some embodiments, the terminal device 110 may receive, from the network device 120, downlink control information (DCI) via a DL control channel transmission. For example, the DL control channel transmission may be a PDCCH transmission. Of course, any other suitable forms are also feasible.

In some embodiments, the terminal device 110 may transmit uplink control information (UCI) to the network device 120 via an UL control channel transmission. For example, the UL control channel transmission may be a PUCCH transmission. Of course, any other suitable forms are also feasible.

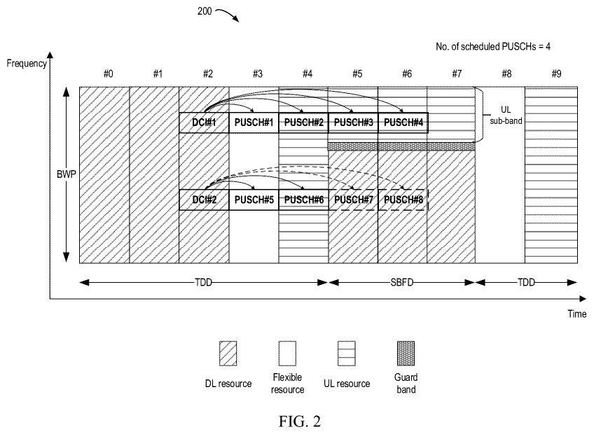

FIG. 2 illustrates a schematic diagram 200 illustrating an example scenario of multiple transmissions in SBFD communication in a related solution. As shown in FIG. 2, slot #0 to slot #4 and slot #8 to slot #9 are half duplex TDD slots and slot #5 to slot #7 are sub-band full duplex slots. It should be understood that time intervals in FIG. 2 may be implemented as symbols, mini-slots or slots. For example, a slot may comprise half duplex TDD symbols and/or sub-band full duplex symbols.

In one embodiment, the network device 120 may schedule four PUSCH transmissions for the terminal device 110. For example, the terminal device 110 may receive, from the network device 120, DCI #1 for scheduling four PUSCH transmissions (i.e., PUSCH #1-PUSCH #4) on slot #3 to slot #6. As another example, the terminal device 110 may receive, from the network device 120, DCI #2 for scheduling four PUSCH transmissions (i.e., PUSCH #5-PUSCH #8) on slot #3 to slot #6. As the slots #3 and #4 are configured as half duplex DL slots and flexible symbols/slots, the terminal device 110 may transmit PUSCH #1-PUSCH #2 or PUSCH #5-PUSCH #6. However, as the symbols/slots #5 and #6 are configured as SBFD symbols/slots, the SBFD symbol/slot may be configured with both DL resources and UL resources in a BWP. In case that PUSCH #7 and PUSCH #8 overlap with DL sub-bands in SBFD symbols/slots, UL transmission of PUSCH #7 and PUSCH #8 cannot be performed by the terminal device 110. In other words, the terminal device 110 cannot determine how to handle multiple transmissions over both TDD symbols/slots and SBFD symbols/slots due to variable frequency domain resources.

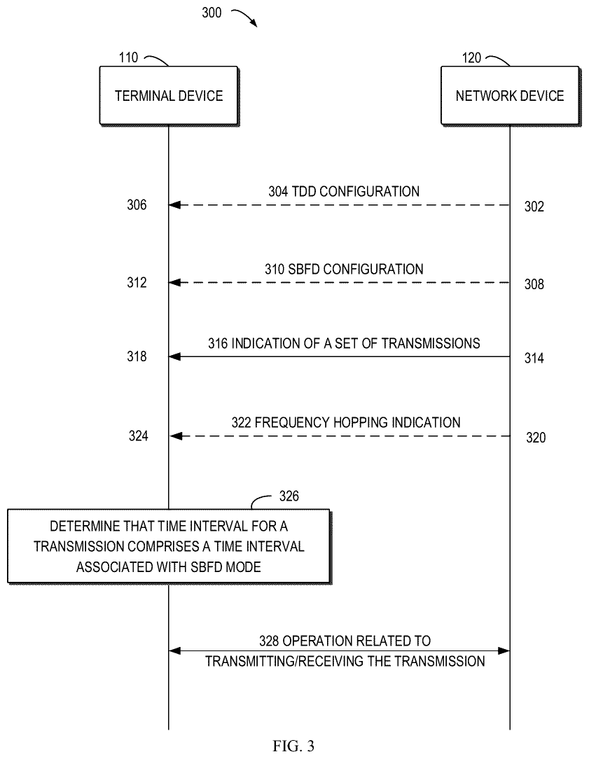

In view of this, embodiments of the present disclosure provide a solution of determining resource allocation to support SBFD operation. The solution will be described in detail with reference to FIGS. 3 to 5C below. FIG. 3 illustrates a schematic diagram illustrating a process 300 of communication for multiple transmissions in SBFD communication according to some embodiments of the present disclosure. For the purpose of discussion, the process 300 will be described with reference to FIG. 1. The process 300 may involve the terminal device 110 and the network device 120 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added.

As shown in FIG. 3, the network device 120 transmits (314), to the terminal device 110, an indication 316 of a set of transmissions to be transmitted or received by the terminal device 110 in a set of time intervals. The terminal device 110 receives (318) the indication 316 of the set of transmissions. A transmission in the set of transmissions is indicated to be transmitted or received by the terminal device 110 in a time interval in the set of time intervals. The set of transmissions may comprise a set of UL transmissions to be transmitted by the terminal device 110 or may comprise a set of DL transmissions to be received by the terminal device 110. In some examples, the set of transmissions may comprise multiple transmissions scheduled by DCI. In some examples, the set of transmissions may comprise multiple configured grant (CG) transmissions. In some examples, the set of transmissions may comprise multiple repetitions of transmissions. Based on pre-configured resource allocation, the terminal device 110 may determine time and frequency resources indicated for each of the set of transmissions.

Upon determining (326) that the time interval for the transmission comprises a time interval associated with sub-band full duplex mode, the terminal device 110 performs an operation (328) related to transmitting or receiving the transmission. Embodiments of the present application define clear UE behavior for SBFD capable UE to transmit or receive multiple transmissions over both UL only symbols/slots and SBFD symbols/slots.

In some embodiments, the network device 120 may transmit (302), to the terminal device 110, TDD configuration 304, e.g., tdd-UL-DL-ConfigurationCommon and/or tdd-UL-DL-ConfigurationDedicated. The terminal device 110 receives (306) the TDD configuration 304 and thus determines the transition direction on a time interval (e.g., symbols/slots). The terminal device 110 considers symbols in a symbol/slot indicated as downlink by tdd-UL-DL-ConfigurationCommon or tdd-UL-DL-ConfigurationDedicated to be available for receptions and considers symbols in a symbol/slot indicated as uplink by tdd-UL-DL-ConfigurationCommon or tdd-UL-DL-ConfigurationDedicated to be available for transmissions. The network device 120 may transmit (308), to the terminal device 110, SBFD configuration 310, e.g., time and frequency resources for UL sub-band. The terminal device 110 receives (312) the SBFD configuration 310 and thus be aware of configuration of SBFD symbols/slots. Based on the TDD configuration and the SBFD configuration, the terminal device 110 may determine whether there is an overlapping between the scheduled transmission and SBFD symbols/slots.

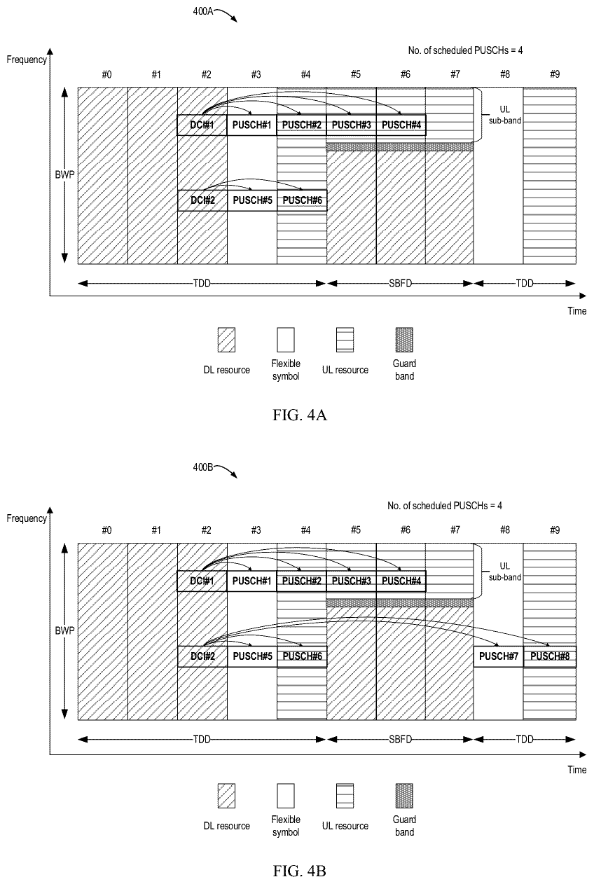

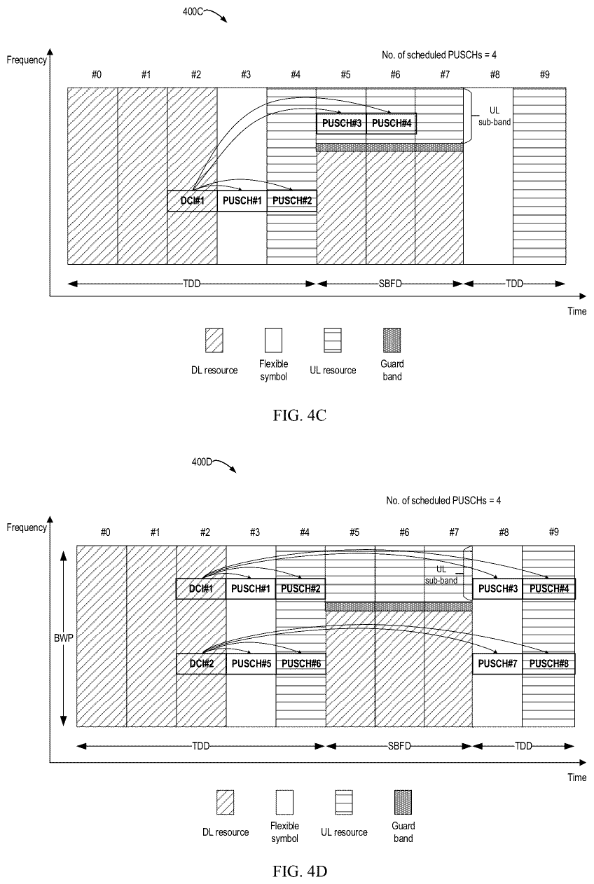

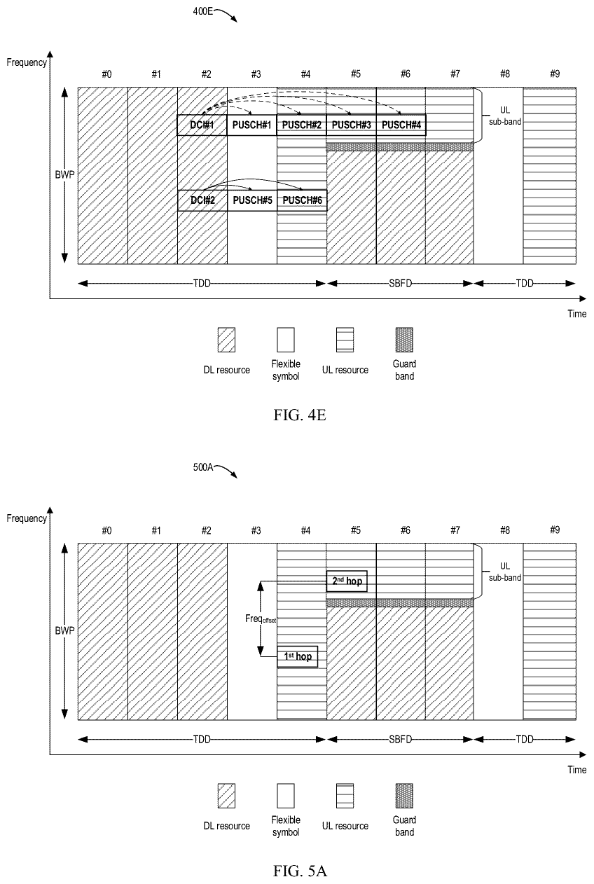

Some example embodiments on performing the operation related to transmitting or receiving the transmission will be described in connection with FIGS. 4A-4E. Although the transmission and reception of multiple PUSCHs scheduled by DCI in DL symbols/slots with UL sub-band are shown in FIGS. 4A-4E, the concepts of these embodiments may also be applied to other UL transmissions such as PUCCH/PRACH/SRS, DL transmission in UL symbols/slots with DL sub-band. In addition, the concepts of these embodiments are not limited to dynamic grant transmissions, but also apply to CG transmissions, transmissions for a dynamic granted (DG) repetition occasion and transmissions for a CG repetition occasion. It should be understood that the number and periodicity of scheduled transmissions are given for the purpose of illustration without suggesting any limitations to the present disclosure.

### Embodiment 1

In this embodiment, the terminal device 110 may determine how to transmit the multiple transmissions overlapped with SBFD symbols/slots based on the frequency resource allocation for these transmissions. For example, if the allocated frequency resource of a UL transmission is located within the UL sub-band in SBFD symbols/slots, the SBFD symbols/slots will be handled as valid/UL symbols/slots for the UL transmission: if the allocated frequency resource of the UL transmission is located in DL sub-band or guard band in SBFD symbols/slots, the SBFD symbols/slots will be handled as invalid/DL symbols/slots for the UL transmission.

In some embodiments, if a frequency resource allocated for the transmission is located within a first sub-band with a first direction in the time interval, the terminal device 110 may determine that the time interval is valid for transmitting or receiving the transmission, wherein the first direction is the same as a direction of the transmission between the terminal device 110 and the network device 120. If the frequency resource is overlapped with a second sub-band with a second direction or overlapped with a guard band between the first sub-band and the second sub-band, the terminal device 110 may determine that the time interval is invalid for transmitting or receiving the transmission, wherein the second direction is different from the first direction. For example, UL transmissions indicated to be transmitted on UL sub-band of SBFD symbol/slot may be transmitted by the terminal device on the SBFD symbol/slot and UL transmissions indicated to be transmitted on DL sub-band or guard band of SBFD symbol/slot would not be transmitted on the SBFD symbol/slot.

For illustration, an example will be described in FIGS. 4A and 4B. FIGS. 4A and 4B illustrate schematic diagrams 400A and 400B illustrating example scenarios of multiple transmissions in SBFD communication according to embodiments of the present disclosure. As shown in FIG. 4A, the BWP in TDD symbols/slots is the same as the BWP in SBFD symbols/slots. A BWP may only comprise one or more sub-band. The terminal device determines the frequency domain resource allocation for PUSCH transmission on UL BWP in TDD symbol and UL sub-band in SBFD symbol is the same, i.e., the indicated frequency resource allocation in the scheduling DCI is applied for both UL only symbol and SBFD symbol. Assuming PUSCH #1-PUSCH #4 scheduled by DCI #1 are indicated to be transmitted across symbols/slots with different duplex types, e.g., UL only symbols/slots (i.e., symbols/slots #3 and #4) and SBFD symbols/slot (i.e., symbols/slots #5 and #6). Frequency resources allocated for PUSCH #3 and PUSCH #4 are located within the UL sub-band in SBFD symbols/slots #5 and #6, the SBFD symbols/slots #5 and #6 will thus be handled as valid symbol for PUSCH transmission. As shown in FIG. 4A, the terminal device 110 may transmit PUSCH #1-PUSCH #4 to the network device 120 at symbol/slot #1 to symbol/slot #4, respectively.

Assuming four PUSCHs scheduled by DCI #2 are indicated to be transmitted across symbols/slots with different duplex types, e.g., UL only symbols/slots (i.e., symbols/slots #3 and #4) and SBFD symbols/slot (i.e., symbols/slots #5 and #6). Frequency resources allocated for the third and fourth PUSCHs are located in DL sub-band in SBFD symbols/slots #5 and #6, the SBFD symbols/slots #5 and #6 will thus be handled as invalid symbol for PUSCH transmission. As shown in FIG. 4A, the terminal device 110 may only transmit PUSCH #5-PUSCH #6 to the network device 120 at symbols/slots #3 and #4, respectively and cancel transmitting the third and fourth PUSCHs.

Alternatively, the invalid symbols/slots may be skipped and transmissions originally allocated to invalid symbols/slots may be postponed to subsequent valid symbols/slots. As shown in FIG. 4B, the terminal device 110 may transmit PUSCH #5-PUSCH #6 to the network device 120 at symbols/slots #3 and #4, respectively: skip invalid symbols/slots #5 to #7; and postpone transmitting PUSCH #7 and PUSCH #8 at symbols/slots #8 and #9, respectively.

The concepts of these embodiments may also be applied to CG transmissions. For example, CG PUSCHs of one CG configuration can be transmitted on both TDD slot and SBFD slot. In case the CG PUSCH occasion is located in a SBFD symbol/slot, the terminal device 110 determines whether the SBFD symbol/slot can be valid to transmit CG PUSCH based on the frequency resource allocation for CG PUSCH. In this embodiment, the BWP in TDD symbols/slots is the same as the BWP in SBFD symbols/slots. A BWP may comprise one or more sub-bands. The terminal device determines the frequency domain resource allocation for CG PUSCH transmission on UL BWP in TDD symbol and UL sub-band in SBFD symbol is the same, i.e., the indicated frequency resource allocation in the activation DCI or configured by RRC is applied for both UL only symbol and SBFD symbol. If the frequency resource allocation of CG PUSCH is located within the UL sub-band in SBFD symbols/slots, the SBFD symbols/slots will be handled as valid/UL symbols/slots for CG PUSCH transmission, and the terminal device 110 will transmit CG PUSCH in the SBFD symbols/slots: otherwise, the SBFD symbols/slots will be handled as invalid symbols/slots for CG PUSCH transmission and the terminal device 110 will cancel/skip the CG PUSCH transmission.

In some embodiments, the set of transmissions are multiple repetitions of the transmission. In some embodiments, when AvailableSlotCounting is enabled, the invalid symbols/slots will be skipped and not counted when determining the time domain resource for the repetitions of transmissions. In some embodiments, if time resource of the transmission is at least partially overlapped with a time interval invalid for transmitting or receiving the transmission, the terminal device 110 may cancel the transmission. For example, if part of an UL transmission overlaps with UL only symbols/slots while another part of the UL transmission overlaps with DL sub-band and/or guard band of a SBFD symbol/slot, the UL transmission would not be transmitted.

In some alternative embodiments, if a first part of time resource of the transmission is overlapped with a time interval invalid for transmitting or receiving the transmission and a second part of the time resource of the transmission is overlapped with a valid time interval associated with a half-duplex mode, the terminal device 110 may transmit or receive part of the transmission located in the valid time interval associated with a half-duplex mode. For example, if part of an UL transmission overlaps with UL only symbols/slots while another part of the UL transmission overlaps with DL sub-band and/or guard band of a SBFD symbol/slot, the terminal device 110 may transmit part of the UL transmission on the UL only symbols/slots by puncture or rate matching. Solutions of embodiment 1 improve spectrum efficiency and scheduling flexibility for the network device, in addition, these solutions can also achieve lower transmission latency.

### Embodiment 2

In this embodiment, the terminal device 110 may always determine SBFD symbols/slots as valid symbols/slots for the transmission. For example, if indicated or configured time domain resources for UL transmissions are all located in UL only symbols/slots and/or UL sub-band of SBFD symbols/slots, the UL transmissions would always be transmitted by the terminal device 110.

In some embodiments, the BWP in TDD symbols/slots is the same as the BWP in SBFD symbols/slots, same frequency resource allocation is determined for transmission on BWP in TDD symbol and sub-band in SBFD symbol. The terminal device 110 expects the allocated frequency resource for transmissions to be limited within the corresponding sub-band in all symbols/slots. In other words, if the frequency resource is overlapped with a second sub-band with a second direction or overlapped with a guard band between the first sub-band and the second sub-band, the terminal device 110 may determine the set of transmissions as an error case, wherein the second direction is different from the first direction. For example, the terminal device 110 does not expect the allocated frequency resource for UL transmissions to be within DL symbols/slots or DL sub-bands or guard bands in SBFD symbols/slots. This solution is simple for UE implementation.

In some alternative embodiments, a bandwidth part (BWP) available for the time interval comprises at least a first sub-band with a first direction and a second sub-band with a second direction in the time interval, wherein the first direction is the same as a direction of the transmission between the terminal device 110 and the network device 120, the second direction being opposite to the first direction. In the context of the present application, the term “available BWP” refers to active BWP or configured BWP. The terminal device 110 may determine a frequency resource allocation of the transmission based on a reference BWP comprising the first sub-band. The terminal device 110 may transmit or receive the transmission in the time interval based on the frequency resource allocation. This solution can guarantee the indicated transmission on SBFD symbols can be transmitted, which achieves lower transmission latency.

For illustration, an example will be described in FIG. 4C. FIG. 4C illustrates a schematic diagram 400C illustrating an example scenario of multiple transmissions in SBFD communication according to embodiments of the present disclosure. The BWP in TDD symbols/slots is the same as the BWP in SBFD symbols/slots, the terminal device 110 may determine a reference BWP (a short UL BWP) for SBFD symbols/slots #5 and #6 based on the BWP configuration for TDD symbols/slots and UL sub-band configuration. The terminal device 110 may determine the frequency resource for PUSCH #3 and PUSCH #4 on the reference BWP in SBFD symbols/slots #5 and #6 in the same way as for BWP switching, e.g., use the x MSB bits in scheduling DCI provide the frequency domain resource allocation. No actual BWP switching happens. The reference BWP for SBFD symbols/slots are only for the purpose of determining frequency resource for transmissions on the SBFD symbols/slots.

In some alternative embodiments, a BWP may only comprise one sub-band. The terminal device 110 may determine a frequency resource allocation of the transmission based on a BWP available for the time interval. The BWP comprises a first sub-band with a first direction in the time interval, wherein the first direction is the same as a direction of the transmission between the terminal device 110 and the network device 120. The terminal device 110 may transmit or receive the transmission in the time interval based on the frequency resource allocation dedicated for the first sub-band in SBFD symbols/slot. In this embodiment, the BWP in TDD symbols/slots is different from the BWP in SBFD symbols/slots. The terminal device 110 may determine the frequency resource for transmissions on TDD symbols/slot and SBFD symbols/slots in the same way as for BWP switching. For example, when a scheduled first UL transmission is located in UL only symbols and a scheduled second UL transmission is located in DL symbols with UL sub-band, the terminal device determines the frequency resource allocation for the first UL transmission in UL only symbols based on the indicated frequency resource allocation in DCI for a first UL BWP configured for TDD symbols, and the terminal device determines the frequency resource allocation for the second UL transmission in UL sub-band in SBFD symbols based on the indicated frequency resource allocation in DCI for a second UL BWP comprising the UL sub-band as the active UL BWP for the terminal device is switched from the first UL BWP to the second UL BWP. The solution can achieve lower latency and has less specification impact.

In some alternative embodiments, the terminal device 110 may receive, from the network device 120, information of frequency resource allocation of the transmission. The information comprises a first frequency resource indicator for a time interval associated with half duplex mode and a second frequency resource indicator for the time interval associated with sub-band full duplex mode. The terminal device 110 may determine a frequency resource allocation of the transmission based on the second frequency resource indicator. The terminal device 110 may transmit or receive the transmission in the time interval based on the frequency resource allocation. In this embodiment, the BWP in TDD symbols/slots may be same or different from the BWP in SBFD symbols/slots. The terminal device 110 may receive two frequency resource indications corresponding to transmissions on TDD symbols/slots and transmissions on SBFD symbols/slots, respectively. Solutions of embodiment 2 enable continuous transmissions of multiple transmissions over TDD symbols/slots and/or SBFD symbols/slots, thereby achieving reduced latency and better coverage.

### Embodiment 3

In this embodiment, multiple transmissions may be transmitted only on one kind of time intervals, e.g., only on TDD symbols/slots or only on SBFD symbols/slots. For example, if the multiple PUSCHs scheduled by a single DCI are transmitted on half duplex TDD symbols/slots, the SBFD symbols/slots will be skipped and not counted when determining the time domain resource for the multiple PUSCHs.

In some embodiments, the terminal device 110 may receive, from the network device 120, an indication whether the set of transmissions are to be transmitted or received in time intervals associated with half duplex mode or in time intervals associated with sub-band full duplex mode by the terminal device 110. If the set of transmissions are to be transmitted or received in time intervals associated with sub-band full duplex mode based on the indication, the terminal device 110 may transmit or receive the transmission in the time interval. If the set of transmissions are to be transmitted or received in time intervals associated with half duplex mode based on the indication, the terminal device 110 may skip the time interval associated with sub-band full duplex mode and postpone transmitting or receiving the transmission to a subsequent time interval associated with half duplex mode.

For illustration, an example will be described in FIG. 4D. FIG. 4D illustrates a schematic diagram 400D illustrating an example scenario of multiple transmissions in SBFD communication according to embodiments of the present disclosure. As shown in FIG. 4D, the PUSCHs scheduled by DCI #1 or DCI #2 are transmitted on half duplex TDD symbols/slots, the SBFD symbols/slots #5 to #7 are skipped and not counted when determining the time domain resource for the multiple PUSCHs.

In some embodiments, the transmissions may be scheduled by a single DCI. The indication may comprise at least one of: an explicit indication in DCI, a type of a first time interval on which a first transmission in the set of transmissions is transmitted or received by the terminal device 110 based on the DCI, a frequency resource allocation in the DCI and a first index of a first BWP in the DCI or a second index of a second BWP in the DCI. The first BWP corresponds to a time interval associated with sub-band full duplex mode, and the second BWP corresponds to a time interval associated with half duplex mode. This solution is simple and clean and enables multiple transmissions are in one kind of TDD symbols/slots and/or SBFD symbols/slots.

In some embodiments, the terminal device 110 may determine whether multiple PUSCHs scheduled by a single DCI are transmitted on TDD symbols/slots or SBFD symbols/slots based on explicit indication in DCI.

In some embodiments, the terminal device 110 may determine whether multiple PUSCHs scheduled by a single DCI are transmitted on TDD symbols/slots or SBFD symbols/slots based on the first symbol/slot format determined by K2 indication for the first PUSCH transmission. If the symbol/slot for the first PUSCH transmission is SBFD symbols/slot, the multiple PUSCHs are determined to be all transmitted on SBFD symbols/slots.

In some embodiments, the terminal device 110 may determine whether multiple PUSCHs scheduled by a single DCI are transmitted on TDD symbols/slots or SBFD symbols/slots based on the frequency resource allocation. For example, if the frequency resource allocated for PUSCH is out of the UL sub-band, the multiple PUSCHs will be all transmitted on TDD symbols/slots, otherwise, the multiple PUSCHs will be all transmitted on SBFD symbols/slots.

In some embodiments, the terminal device 110 may determine whether multiple PUSCHs scheduled by a single DCI are transmitted on TDD symbols/slots or SBFD symbols/slots based on BWP indication in the scheduling DCI. In this embodiment, the BWP in TDD symbols/slots is different from the BWP in SBFD symbols/slots. For example, a BWP for SBFD symbol may only comprise one sub-band. The terminal device 110 may determine the symbol/slot type for multiple transmissions based on corresponding BWP ID.

In some alternative embodiments, the transmissions may be CG transmissions configured by a RRC configuration and/or activated by activation DCI. If CG transmissions are configured to be transmitted on TDD symbols/slots, SBFD symbols/slots will not be counted when calculating the time domain location of CG PUSCH occasion based on the periodicity configuration. If CG transmissions are configured to be transmitted on SBFD symbols/slots, TDD symbols/slots (UL/flexible symbols/slots configured by tdd-UL-DL-ConfigurationCommon/tdd-UL-DL-ConfigurationDedicated) will not be counted when calculating the CG periodicity. The indication may comprise at least one of: presence or absence of sub-band information in an activation DCI, a type of a first time interval on which a first transmission in the set of transmissions is transmitted or received by the terminal device 110 based on the activation DCI, a CG (configured grant) configuration index indication in the activation DCI and RRC configuration for a first set of CG configuration index or a second set of CG configuration index. The first set of CG configuration index corresponds to a time interval associated with sub-band full duplex mode, and, the second set of CG configuration index corresponds to a time interval associated with half duplex mode. For example, if the activation DCI includes UL sub-band information, the CG configuration is only for SBFD symbols/slots: otherwise, the CG UL configuration is for TDD symbols/slots. In some embodiments, the terminal device 110 may determine whether CG transmissions are transmitted on TDD symbols/slots or SBFD symbols/slots based on the symbol/slot format of the first CG transmission determined by K2 indication in the activation DCI. In some embodiments, different CG ID may be configured for TDD symbols/slots and SBFD symbols/slots and the terminal device 110 may determine whether CG transmissions are transmitted on TDD symbols/slots or SBFD symbols/slots based on corresponding CG ID. This solution is simple and clean and enables multiple transmissions are transmitted in one kind of TDD symbols/slots and/or SBFD symbols/slots, thereby achieving lower specification impact.

In some alternative embodiments, CG PUSCHs of one CG configuration is only transmitted on TDD symbols/slots. The SBFD symbols/slots are only valid for dynamic scheduling, e.g., DG PUSCH scheduled on UL sub-band in a DL symbols/slots configured by tdd-UL-DL-ConfigurationCommon/tdd-UL-DL-ConfigurationDedicated. In case the CG PUSCH occasion overlaps with SBFD symbols/slots determined based on periodicity parameter, the terminal device 110 determines the symbols/slots as invalid symbols/slots and cancels the CG PUSCH transmission. This solution does not have spec impact and a simple and clear scheduling scheme is provided.

### Embodiment 4

In this embodiment, in case a transmission occasion overlaps with SBFD symbols/slots (and TDD symbols/slots), the terminal device 110 determines whether the SBFD symbols/slots are valid symbols/slots or invalid symbols/slots for the transmission based on the scheduling DCI indication. For example, if DCI indicates the SBFD symbols/slots as invalid symbols/slots for PUSCH transmission (for example due to the presence of interference on the SBFD symbols/slots), when a PUSCH occasion overlaps with SBFD symbol, the PUSCH occasion is an invalid PUSCH and the terminal device 110 will not transmit the PUSCH.

In some embodiments, upon receiving an indication that time intervals associated with sub-band full duplex mode are valid time intervals for the set of transmissions, the terminal device 110 may transmit or receive the transmission in the time interval. Upon receiving an indication that time intervals associated with sub-band full duplex mode are invalid time intervals for the set of transmissions, the terminal device 110 may cancel the transmission or postpone transmitting or receiving the transmission to a subsequent time interval associated with half duplex mode. Considering the cross link interference for transmission in SBFD symbol, this solution of embodiment 4 enhances the flexibility of the transmissions in SBFD symbols/slots for link adaption with different channel condition.

### Embodiment 5

In this embodiment, the terminal device 110 does not expect multiple transmissions to cross different symbols/slots with opposite transmission directions provided by tdd-UL-DL-ConfigurationCommon or tdd-UL-DL-ConfigurationDedicated, e.g., UL only symbols/slots and DL symbols/slots with UL sub-band, or DL only symbols/slots and UL symbols/slots with DL sub-band.

In some embodiments, if the time interval is a time interval associated with sub-band full duplex mode and a further time interval in the set of time intervals is a time interval associated with half duplex mode and that a further transmission in the set of transmissions is indicated to be transmitted or received by the terminal device 110 in the further time interval, the terminal device 110 may determine the set of transmissions as an error case.

For illustration, an example will be described in FIG. 4E. FIG. 4E illustrates a schematic diagram 400E illustrating an example scenario of multiple transmissions in SBFD communication according to embodiments of the present disclosure. For example, the network device 120 would not schedule resources crossing UL symbols/slots and DL symbols/slots with UL sub-band for multiple UL transmissions. As shown in FIG. 4E, the four PUSCHs scheduled by DCI #1 would cross UL symbols/slots and DL symbols/slots with UL sub-band. If the terminal device 110 receives DCI #1, the terminal device 110 would determine it as an error case. The two PUSCHs scheduled by DCI #2 are only located on flexible symbols/slots and UL symbols/slots, the terminal device 110 thus will transmit the two PUSCHs scheduled by DCI #2. This solution of embodiment 5 reduces complexity of transmissions in SBFD scheme.

### Embodiment 6

In this embodiment, frequency hopping may be enabled for the terminal device 110. The terminal device 110 may determine how to transmit a hop of transmission overlapped with SBFD symbols/slots based on the frequency resource determination for the hop of transmission. This embodiment of the present application defines clear UE behavior for SBFD capable UE to operate UL transmission overlapped with SBFD symbols/slots when frequency hopping is enabled for the UL transmission.

In some embodiments, the network device 120 may transmit (320), to the terminal device 110, a frequency hopping indication 322 of the set of transmissions. The terminal device 110 may receive (320) the frequency hopping indication and transmit a plurality of transmissions in the set of transmissions using a first frequency resource and a second frequency resource alternately based on the frequency hopping indication.

In some embodiments, inter-slot frequency hopping may be applied to the plurality of transmissions. For example, the odd-numbered transmissions may be indicated to be transmitted or received using the first frequency resource; and the even-numbered transmissions may be indicated to be transmitted or received using the second frequency resource. In some embodiments, the second frequency resource may be determined based on the first frequency resource and a frequency offset.

In case of inter-slot frequency hopping and when PUSCH-DMRS-Bundling is not enabled, the starting RB during slot

$${n}_{s}^{μ}$$

is given by equation (1):

$$R {B}_{start} ( {n}_{s}^{μ} ) = \{ \begin{matrix}{RB}_{start} & {n}_{s}^{μ} mod 2 = 0 \\ ( {RB}_{start} + R {B}_{offset} ) mod {N}_{BWP}^{s i z e} & {n}_{s}^{μ} mod 2 = 1\end{matrix} , \qquad ( 1 )$$

where

$${n}_{s}^{μ}$$

is the current slot number within a system radio frame, where a multi-slot PUSCH transmission can take place, RBₛₜₐᵣₜ is the starting RB within the UL BWP, as calculated from the resource block assignment information of resource allocation type 1 (described in Clause 6.1.2.2.2) and RB_{offset} is the frequency offset in RBs between the two frequency hops.

In case of inter-slot frequency hopping and when PUSCH-DMRS-Bundling is enabled, the starting RB during slot

$${n}_{s}^{μ}$$

is given by equation (2):

$$R {B}_{start} ( {n}_{s , f}^{μ} ) = \{ \begin{matrix}{RB}_{s t a r t} & ⌊ \frac{{n}_{s , f}^{μ} + {n}_{f} \cdot {N}_{slot}^{frame , μ}}{{N}_{F H}} ⌋ mod 2 = 0 \\ ( {RB}_{start} + {RB}_{offset} ) mod {N}_{B W P}^{s i z e} & ⌊ \frac{{n}_{s , f}^{μ} + {n}_{f} \cdot {N}_{slot}^{frame , μ}}{{N}_{F H}} ⌋ mod 2 = 1\end{matrix} \qquad ( 2 )$$

where

$${n}_{s , f}^{μ}$$

is the current slot number within a system radio frame, n_{f} is the number of the system radio frame containing the current slot,

$${N}_{slot}^{frame , μ}$$

is the number of slots per frame for subcarrier spacing configuration u of the UL BWP that the PUSCH is transmitted on, N_{FH} is the value of the higher layer parameter PUSCH-Frequencyhopping-Interval, RBₛₜₐᵣₜ is the starting RB within the UL BWP, as calculated from the resource block assignment information of resource allocation type 1 (described in Clause 6.1.2.2.2) and RB_{offset} is the frequency offset in RBs between the two frequency hops.

In some alternative embodiments, intra-slot frequency hopping may be applied to each of the plurality of transmissions. For example, a first portion of each transmission may be indicated to be transmitted or received using the first frequency resource; and a second portion of each transmission may be indicated to be transmitted or received using the second frequency resource.

In case of intra-slot frequency hopping, the starting RB in each hop is given by equation (3):

$$R {B}_{start} = \{ \begin{matrix}{RB}_{start} & i = 0 \\ ( {RB}_{start} + {RB}_{offset} ) mod N {}_{BWP}^{size} & i = 1\end{matrix} , \qquad ( 3 )$$

where i=0 and i=1 are the first hop and the second hop respectively, and RBₛₜₐᵣₜ is the starting RB within the UL BWP, as calculated from the resource block assignment information of resource allocation type 1 (described in Clause 6.1.2.2.2) or as calculated from the resource assignment for MsgA PUSCH (described in [6, TS 38.213]) and RB_{offset} is the frequency offset in RBs between the two frequency hops. The number of symbols in the first hop is given by

$$⌊ {N}_{s y m b}^{PUSCH , s} / 2 ⌋ ,$$

the number of symbols in the second hop is given by

$${N}_{s y m b}^{PUSCH , s} - ⌊ {N}_{s y m b}^{PUSCH , s} / 2 ⌋ ,$$

where

$${N}_{s y m b}^{PUSCH , s}$$

is the length of the PUSCH transmission in OFDM symbols in one slot.

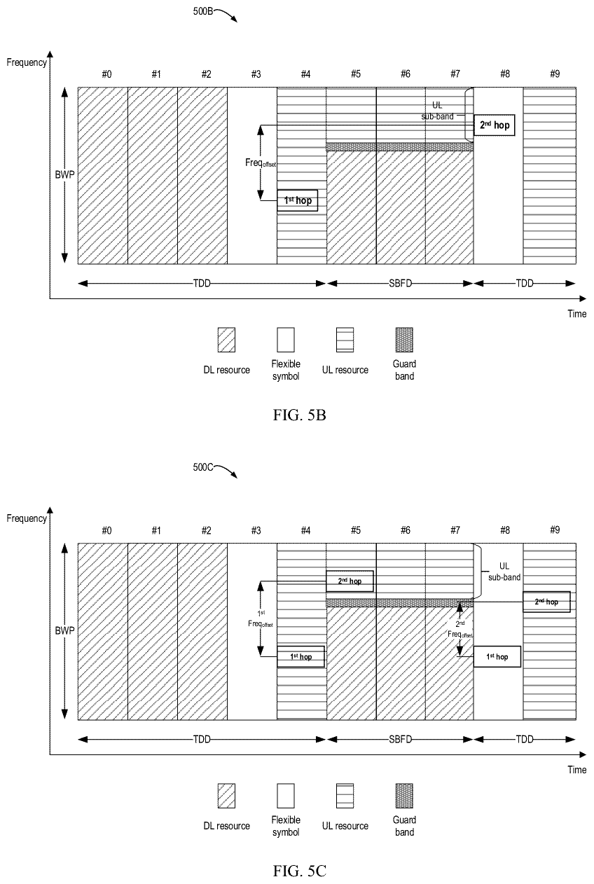

The terminal device 110 may determine how to handle the transmission with variable frequency domain resources due to frequency hopping. Some example embodiments on performing the operation related to transmitting a hopping of transmission will be described in connection with FIGS. 5A-5C. It should be understood the first hop of transmission may be odd-numbered transmissions in inter-slot frequency hopping and the second hop of transmission may be even-numbered transmissions in inter-slot frequency hopping: or the first hop of transmission may be a first portion of each transmission (e.g., a first portion of a PUSCH) in intra-slot frequency hopping and the second hop of transmission may be a second portion of the corresponding transmission (e.g., a second portion of the PUSCH) in intra-slot frequency hopping.

In some embodiments, if a first hop of transmission is overlapped with a time interval associated with half-duplex mode and a second hop of transmission is overlapped with the time interval associated with sub-band full duplex mode, the terminal device 110 may cancel transmitting the second hop of the transmission if the time interval associated with sub-band full duplex mode is invalid for transmitting the second hop of the transmission. In other words, the terminal device 110 may determine whether to transmit the hop of the transmission based on the corresponding frequency resource allocation. If the hop of the transmission is located in UL sub-band in the allocated SBFD symbols/slots, indicating that the allocated SBFD symbols/slots are valid for transmitting the hop, the terminal device 110) then transmits the hop on the allocated SBFD symbols/slots. If the hop of the transmission is located in DL sub-band or guard band in the allocated SBFD symbols/slots, indicating that the allocated SBFD symbols/slots are invalid for transmitting the hop, the terminal device 110 then cancels transmitting the hop

For illustration, an example will be described in FIG. 5A. FIG. 5A illustrates a schematic diagram 500A illustrating an example scenario of transmissions with frequency hopping in SBFD communication according to embodiments of the present disclosure. As shown in FIG. 5A, the first hop of transmission in intended to be transmitted by the terminal device 110 at TDD symbol/slot #4 at a first frequency resource; and the second hop of transmission in intended to be transmitted by the terminal device 110 at SBFD symbol/slot #5 at a second frequency resource. The determined frequency resource for the second hop of transmission is located in the UL sub-band of SBFD symbol/slot #5 and doesn't overlaps with DL/SSB symbols/slots. The SBFD symbol/slot #5 is thus valid for the second hop of transmission and the terminal device 110 transmits the second hop of transmission. In some embodiments, if the determined frequency resource for the second hop of transmission is located in the DL sub-band or guard band of SBFD symbol/slot #5, the second hop of transmission will be cancelled. In this way, flexible scheduling scheme may be provided.

In some alternative embodiments, if a first hop of transmission is overlapped with a time interval associated with half-duplex mode and a second hop of transmission is overlapped with the time interval associated with sub-band full duplex mode, the terminal device 110 may postpone transmitting the second hop of the transmission to a subsequent time interval associated with half duplex mode. In other words, the terminal device 110 only performs frequency hopping on one of kind of time intervals, e.g., only TDD symbols/slots or only SBFD symbols/slots.

For illustration, an example will be described in FIG. 5B. FIG. 5B illustrates a schematic diagram 500B illustrating an example scenario of transmissions with frequency hopping in SBFD communication according to embodiments of the present disclosure. The terminal device 110 may only perform frequency hopping on one of kind of symbols/slots, e.g., TDD symbols/slots or SBFD symbols/slots. As shown in FIG. 5B, if the first hop of transmission is located in TDD symbols (e.g., UL symbols) in a symbol/slot #4, the slots #5 to #7 with UL sub-band will be skipped when determining the time resource for the second hop of transmission. The second hop of transmission will be delayed to next TDD slot, e.g., TDD flexible symbol/slot #8 as shown in FIG. 5B. In this way, variable frequency domain resources for transmissions with frequency hopping may be avoided and flexible scheduling scheme may be provided.

In some alternative embodiments, if a second hop of transmission is indicated to be transmitted by the terminal device 110 using the second frequency resource, the terminal device 110 may determine the second frequency resource based on the first frequency resource and a first frequency offset associated with the time interval associated with sub-band full duplex mode. The first frequency offset is different from a second frequency offset associated with a time interval associated with half duplex mode. The terminal device 110 may transmit the second hop of transmission using the second frequency resource in the time interval.

For illustration, an example will be described in FIG. 5C. FIG. 5C illustrates a schematic diagram 500C illustrating an example scenario of transmissions with frequency hopping in SBFD communication according to embodiments of the present disclosure. The network device 120 may separately configure/indicate two frequency offsets for TDD symbols/slots and SBFD symbols/slots. The terminal device 110 may perform frequency hopping for PUSCH based on symbol/slot type of the time domain resource allocated for the hop of transmission and the associated frequency offset. As shown in FIG. 5C, the first frequency offset for the hop of transmission in SBFD symbol/slot #5 is different from the second frequency offset for the hop of transmission in TDD symbol/slot #9. In this way, continuous transmissions of multiple transmissions with frequency hopping over TDD symbols/slots and SBFD symbols/slots can be achieved, thereby achieving reduced latency and better coverage.

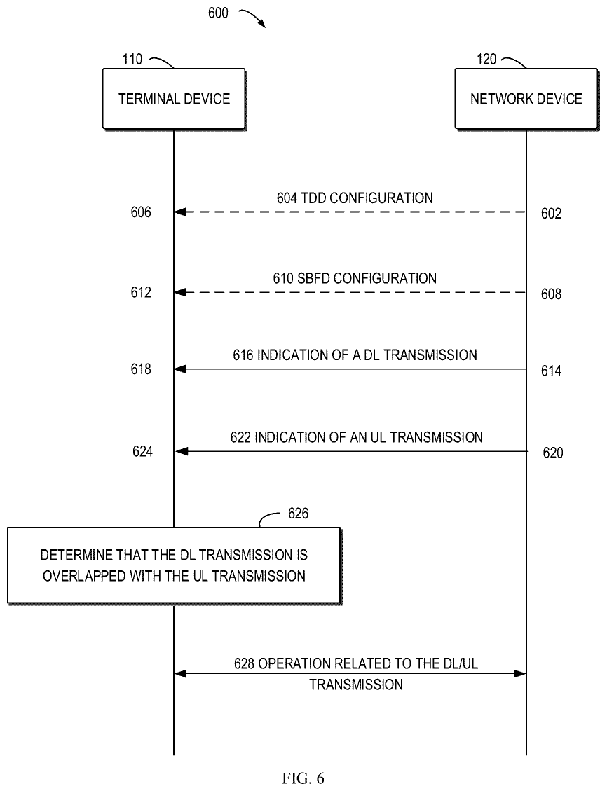

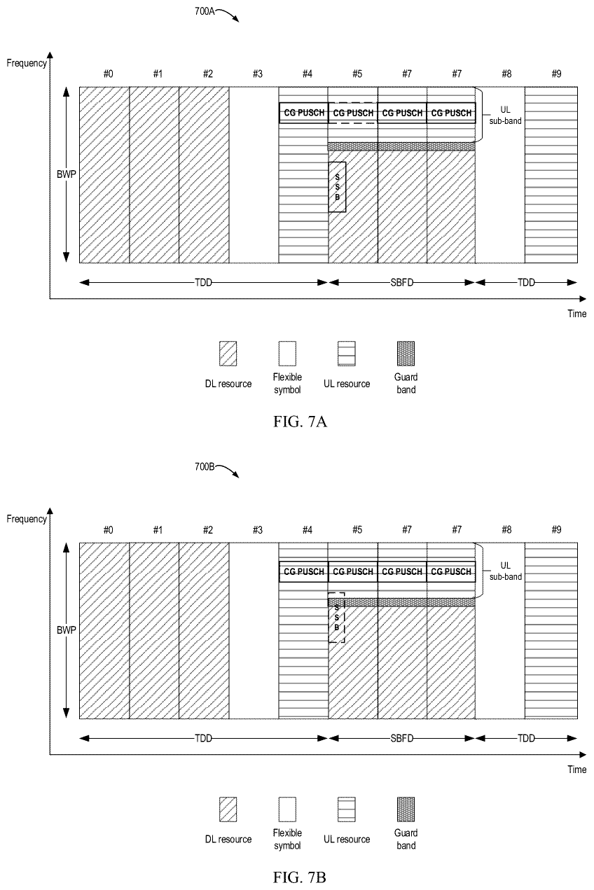

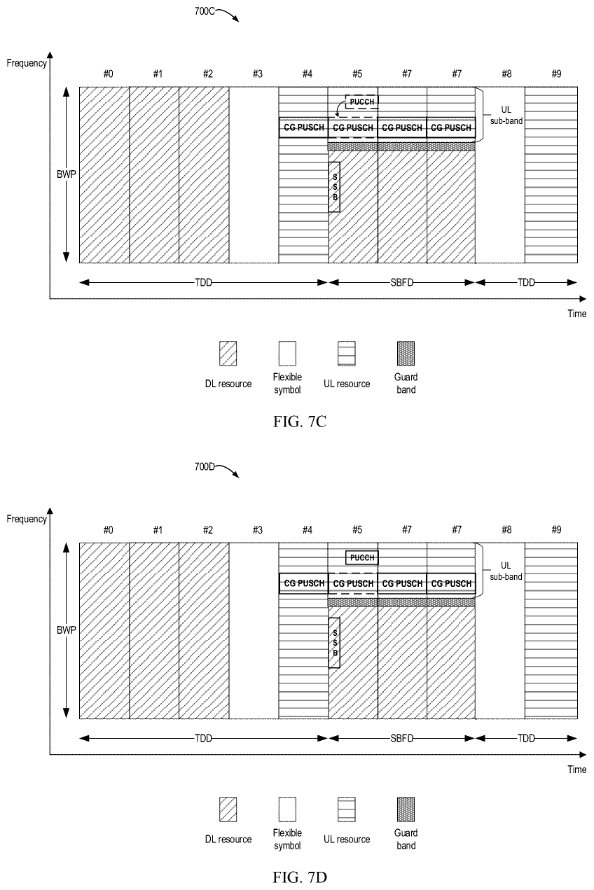

In addition, potential collision between higher configured DL transmission and UL transmission may happen in a SBFD symbol/slot, and how to handle such collision case is not clear. In view of this issue, embodiments of the present disclosure provide a solution of handling potential collision in SBFD symbols/slots to support SBFD operation. The solution will be described in detail with reference to FIGS. 6 to 7D below. FIG. 6 illustrates a schematic diagram illustrating a process 600 of communication for DL transmission and UL transmission in SBFD communication according to embodiments of the present disclosure. For the purpose of discussion, the process 600 will be described with reference to FIG. 1. The process 600 may involve the terminal device 110 and the network device 120 as illustrated in FIG. 1. It is to be understood that the steps and the order of the steps in FIG. 6 are merely for illustration, and not for limitation. For example, the order of the steps may be changed. Some of the steps may be omitted or any other suitable additional steps may be added.

As shown in FIG. 6, the network device 120 transmits (614), to the terminal device 110, an first indication 616 of a DL transmission be received by the terminal device 110 in a DL sub-band in a time interval associated with sub-band full duplex mode. The network device 120 transmits (620), to the terminal device 110, a second indication 622 of a first UL transmission to be transmitted by the terminal device 110 in an UL sub-band in the time interval associated with sub-band full duplex mode. The terminal device 110 receives (618, 624) the first indication 616 of the DL transmission and the second indication 622 of the first UL transmission. Based on pre-configured resource allocation, the terminal device 110 may determine time and frequency resources indicated for the DL transmission and the first UL transmission.

Upon determining (626) that the DL transmission is overlapped with the first UL transmission in time domain, the terminal device 110 performs an operation (628) related to the DL transmission or the first UL transmission. Embodiments of the present application define clear UE behavior for SBFD capable UE to handle the collision between UL transmission and DL transmission in SBFD symbols/slots.

In some embodiments, the network device 120 may transmit (602), to the terminal device 110, TDD configuration 604, e.g., tdd-UL-DL-ConfigurationCommon and/or tdd-UL-DL-ConfigurationDedicated. The terminal device 110 receives (606) the TDD configuration 604 and thus determines the transition direction on a time interval (e.g., symbols/slots). The network device 120 may transmit (608), to the terminal device 110, SBFD configuration 610, e.g., time and frequency resources for UL sub-band. The terminal device 110 receives (612) the SBFD configuration 610 and thus be aware of configuration of SBFD symbols/slots. Based on the TDD configuration and the SBFD configuration, the terminal device 110 may determine time and frequency resources indicated for the scheduled transmission.

Some example embodiments on performing the operation related to transmitting or receiving the transmission will be described in connection with FIGS. 7A-7D. Although the DL transmission is illustrated as SSB and the first UL transmission is illustrated as PUSCH in FIGS. 7A-7D, the concepts of these embodiments may be applied to other DL and UL transmissions. It should be understood that the number and periodicity of scheduled transmissions and the number of transmissions in one SBFD symbol/slot are given for the purpose of illustration without suggesting any limitations to the present disclosure.

### Embodiment 7

In this embodiment, a behavior for handling collision between UL transmission and DL transmission in SBFD symbols/slots may be predefined. For instance, in some embodiments, behavior for handling the collision between UL transmission and DL transmission in SBFD symbols/slots may be determined based on predefined priorities of the UL transmission and the DL transmission. For example, if a priority of the first UL transmission is lower than a priority of the DL transmission, the terminal device 110 may drop the first UL transmission and receives the DL transmission. If a priority of the DL transmission is lower than a priority of the UL transmission, the terminal device 110 may stop receiving the DL transmission and transmits the UL transmission.

In some embodiments, if the DL transmission is a Semi Persistent Scheduling Physical Downlink Shared Channel (SPS PDSCH), the terminal device 110 stops receiving the SPS PDSCH and performs transmitting the first UL transmission. In some embodiments, if the first UL transmission is a Physical Random Access Channel (PRACH), the terminal device 110 stops receiving the DL transmission and performs transmitting the UL transmission.

In some alternative embodiments, behavior for handling collision between UL transmission (e.g., DG PUSCH (single PUSCH scheduling), multiple PUSCH scheduled by single DCI, CG PUSCH/PUCCH, PUSCH/PUCCH repetition and PRACH) and DL transmission (e.g., SSB, SPS PDSCH and multiple PDSCH scheduled by single DCI) in SBFD symbols/slots may be predefined according to Table 1.

TABLE 1

| Collision | | | Multiple PDSCH |
|---|---|---|---|
| case | SSB | SPS PDSCH | scheduled by single DCI |
| DG PUSCH | Error case | UE transmits DG PUSCH, | Example 1: UE transmits |
| (single | | cancels the Rx for SPS PDSCH | DG PUSCH, cancels the |
| PUSCH | | and doesn't report HARQ-ACK | Rx for overlapped PDSCH. |
| scheduling) | | feedback for the PDSCH. | Example 2: Error case |
| Multiple | UE cancels | Example 1: UE transmits the | Error case |
| PUSCH | the PUSCH | PUSCH, cancels the Rx for SPS | |
| scheduled by | transmission and | PDSCH and doesn't report | |
| single DCI | receives SSB. | HARQ-ACK feedback for the | |
| | | PDSCH. | |
| | | Example 2: error case | |
| CG | | UE transmits CG PUSCH, | Example 1: UE cancels |
| PUSCH/PUCCH | | cancels the Rx for SPS PDSCH | the overlapped CG UL |
| | | and doesn't report HARQ-ACK | transmission, and |
| | | feedback for the PDSCH. | receives the PDSCH; |
| | | | Example 2: UE transmits |
| | | | CG UL transmission and |
| | | | cancels the reception for |
| | | | overlapped PDSCH. |
| PUSCH/PUCCH | | Example 1: UE transmits | UE cancels the |
| repetition | | PUSCH/PUCCH Repetition, | overlapped UL |
| | | cancels the reception for SPS | Repetition, and |
| | | PDSCH and doesn't report | receives the PDSCH |
| | | feedback for the PDSCH | |
| | | Example 2: UE cancels the | |
| | | overlapped UL Repetition, and | |
| | | receives the SPS PDSCH. | |
| | | Example 3: Controlled by | |
| | | Network device | |
| PRACH | | UE transmits PRACH, cancels | UE transmits PRACH, |
| | | the reception for SPS PDSCH | cancels the reception |
| | | and doesn't report HARQ-ACK | for overlapped PDSCH. |
| | | feedback for the PDSCH. | |

For illustration, an example will be described in FIG. 7A. FIG. 7A illustrates a schematic diagram 700A illustrating an example scenario of UL transmission and DL transmission in SBFD communication according to embodiments of the present disclosure. As shown in FIG. 7A, since CG PUSCH transmission is overlapped with SSB transmission in SBFD symbol/slot #5, the terminal device 110 cancels the CG PUSCH transmission and receives the SSB transmission in SBFD symbol/slot #5. In this way, a simple and clear scheduling scheme with respect to collision between UL transmission and DL transmission is provided.

### Embodiment 8

In this embodiment, the handling sequence of an overlapping between DL transmission and UL sub-band and a potential collision between DL transmission and UL transmission in SBFD symbols/slots may be predefined. For example, in some embodiments, the terminal device 110 may firstly handle the overlapping between DL transmission and UL sub-band, e.g., cancelling the DL transmission or only transmitting the DL transmission in the frequency resources in DL sub-band. After the overlapping between DL transmission and UL sub-band is resolved, the terminal device 110 may then resolve the potential collision between DL transmission and UL transmission, if any. It can avoid some unnecessary UL transmission dropping.

For example, if the DL transmission is to at least partially overlap with the UL sub-band or a guard band between the UL sub-band and the DL sub-band, the terminal device 110 may cancel the DL transmission. Alternatively, if the DL transmission is to at least partially overlap with the UL sub-band or a guard band between the UL sub-band and the DL sub-band, the terminal device 110 may determine part of the DL transmission located in the DL sub-band as a target DL transmission. When there is no overlapping between the DL transmission and the UL sub-band, if the DL transmission is to overlap with the first UL transmission in time domain, the terminal device 110 may resolve a potential collision between the DL transmission and the first UL transmission.

For illustration, an example will be described in FIG. 7B. FIG. 7B illustrates a schematic diagram 700B illustrating an example scenario of UL transmission and DL transmission in SBFD communication according to embodiments of the present disclosure. As shown in FIG. 7B, in SBFD symbol/slot #5, a CG PUSCH transmission is overlapped with SSB transmission and part of the SSB transmission is overlapped with the UL sub-band and guard band. In some embodiments, the terminal device 110 may cancel the SSB transmission in order to resolve the overlapping between SSB transmission and UL sub-band. Since the SSB transmission is cancelled, the CG PUSCH transmission may be transmitted by the terminal device 110 in SBFD symbol/slot #5.

Alternatively, the terminal device 110 may determine part of the SSB transmission located at the DL sub-band as target DL transmission in order to resolve the overlapping between SSB transmission and UL sub-band. Since CG PUSCH transmission is overlapped with determined target DL transmission (i.e., the part of the SSB transmission located at the DL sub-band) in SBFD symbol/slot #5, the terminal device 110 may cancel the CG PUSCH transmission and receive the part of the SSB transmission located at the DL sub-band in SBFD symbol/slot #5.

In some alternative embodiments, the terminal device 110 may firstly handle the overlapping between DL transmission and UL transmission, e.g., based on predefined priority: After the potential collision between DL transmission and UL transmission is resolved, the terminal device 110 may then handle the overlapping between DL transmission and UL sub-band, e.g., cancelling the DL transmission or only transmitting the DL transmission in the frequency resources in DL sub-band. For example, if the DL transmission is to overlap with the first UL transmission in time domain, the terminal device 110 may determine one of the first UL transmission and the DL transmission as a target transmission to resolve a potential collision between the first UL transmission and the DL transmission. When there is no potential collision between the DL transmission and the first UL transmission, if the DL transmission is to at least partially overlap with the UL sub-band, the terminal device 110 may cancel the DL transmission or only receive part of the DL transmission located in the DL sub-band. The solution can proved a unified collision handling rule for overlapping between DL transmission and UL transmission in SBFD symbols.

For example, in the scenario as shown in FIG. 7B, since CG PUSCH transmission is overlapped with SSB transmission in SBFD symbol/slot #5, the terminal device 110 may cancel the CG PUSCH transmission in SBFD symbol/slot #5 and determine the SSB transmission as a target transmission. When there is overlapping between the SSB transmission and UL sub-band, the terminal device 110 may cancel the SSB transmission or only receive the part of the SSB transmission located at the DL sub-band in SBFD symbol/slot #5. Solutions of embodiment 8 provide a simple and clear scheduling scheme with respect to coexistence of collision between UL transmission and DL transmission and overlapping between DL transmission and UL sub-band.

### Embodiment 9

In this embodiment, the handling sequence of a potential collision between multiple UL transmissions and a potential collision between DL transmission and UL transmission in SBFD symbols/slots may be predefined. For example, in some embodiments, the terminal device 110 may firstly handle the potential collision between multiple UL transmissions, e.g., by reusing multiplexing/prioritization rule in Rel-16/Rel-17. When there is no potential collision between UL transmissions in the SBFD symbols/slots, the terminal device 110 may then handle the potential collision between DL transmission and UL transmission in SBFD symbols/slots, if any, e.g., by following the predefined rules in Table 1.

For example, the terminal device 110 may receive, from the network device 120, a third indication of a second UL transmission to be transmitted by the terminal device 110 in the UL sub-band in the time interval associated with sub-band full duplex mode. If the second UL transmission is to overlap with the first UL transmission in time domain, the terminal device 110 may firstly determine a target UL transmission based on the first UL transmission and the second UL transmission to resolve a potential collision between the first UL transmission and the second UL transmission. In some embodiments, the target UL transmission may be one of: the first UL transmission, the second UL transmission, or an adjusted first UL transmission determined by multiplexing a portion of UCI on the second UL transmission in the first UL transmission. After resolving potential collisions between UL transmissions, the terminal device 110 may the resolve a potential collision between the DL transmission and the target UL transmission.

For illustration, an example will be described in FIG. 7C. FIG. 7C illustrates a schematic diagram 700C illustrating an example scenario of UL transmissions and DL transmission in SBFD communication according to embodiments of the present disclosure. As shown in FIG. 7C, in SBFD symbol/slot #5, a CG PUSCH transmission is overlapped with SSB transmission and PUCCH transmission. In some embodiments, in order to resolve the overlapping between CG PUSCH transmission and PUCCH transmission in SBFD symbol/slot #5, the terminal device 110 may multiplex UCI in the PUCCH transmission onto CG PUSCH transmission. The CG PUSCH transmission with multiplexed UCI may be determined as a target UL transmission and the PUCCH transmission may be cancelled. Since CG PUSCH transmission is overlapped with SSB transmission in SBFD symbol/slot #5, the terminal device 110 may cancel the CG PUSCH transmission with multiplexed UCI and receive the SSB transmission in SBFD symbol/slot #5.

In some alternative embodiments, the terminal device 110 may firstly handle the potential collision between DL transmission and UL transmission in SBFD symbols/slots, e.g., by following the predefined rules in Table 1. When there is no potential collision between UL transmissions in the SBFD symbols/slots, the terminal device 110 may then handle the potential collision between multiple UL transmissions, if any, e.g., by reusing multiplexing/prioritization rule in Rel-16/Rel-17. For example, in case the first UL transmission is to overlap with both the DL transmission and the second UL transmission in time domain, the terminal device 110 may firstly determine one of the first UL transmission and the DL transmission as a target transmission to resolve a potential collision between the first UL transmission and the DL transmission. The terminal device 110 may then resolve a potential collision between the target transmission and the second UL transmission, if any:

For illustration, an example will be described in FIG. 7D. FIG. 7D illustrates a schematic diagram 700D illustrating an example scenario of UL transmissions and DL transmission in SBFD communication according to embodiments of the present disclosure. As shown in FIG. 7D, in SBFD symbol/slot #5, a CG PUSCH transmission is overlapped with SSB transmission and PUCCH transmission. In some embodiments, in order to resolve the overlapping between CG PUSCH transmission and SSB transmission in SBFD symbol/slot #5, the terminal device 110 may cancel the CG PUSCH transmission and determine the SSB transmission as a target transmission. Since there is no overlapping between the SSB transmission and PUCCH transmission, the terminal device 110 may first receive the SSB transmission from the network device 120 and then transmit the PUCCH transmission to the network device 120. Assuming the processing time for resolving the overlapping and/or the for switch reception to transmission is satisfied. Solutions of embodiment 9 provide a simple and clear scheduling scheme with respect to coexistence of collision between UL transmissions and collision between UL transmission and DL transmission, without the solution, the terminal device and the network device may have different understanding on whether to operate UL transmission or DL transmission, it may degrade the transmission performance.

### Embodiment 10

In this embodiment, the handling sequence of a potential collision between multiple UL transmissions and a potential collision between DL transmission and UL transmission in SBFD symbols/slots may be determined based on sequential order. In other words, the collision between multiple UL transmissions and the collision between DL transmission and UL transmission in the same SBFD symbol/slot may be handled in a sequential order. For example, if an overlapping between the DL transmission and the first UL transmission in time domain is earlier than an overlapping between the first and second UL transmissions in time domain, the terminal device 110 may first determine one of the DL transmission and the first UL transmission as a target transmission to resolve a potential collision between the DL transmission and the first UL transmission. If the overlapping between the first and second UL transmissions in time domain is earlier than the overlapping between the DL transmission and the first UL transmission in time domain, the terminal device 110 may first determine a target UL transmission based on the first and second UL transmissions to resolve a potential collision between the first and second UL transmissions.

For example, in the scenario as shown in FIG. 7D, since overlapping between the SSB transmission and CG PUSCH transmission in time domain is earlier than the overlapping between the CG PUSCH transmission and the PUCCH transmission in time domain, the terminal device 110 may first handle the overlapping between the SSB transmission and CG PUSCH transmission. The CG PUSCH transmission in SBFD symbol/slot #5 may be cancelled and the SSB transmission may be determined as a target transmission. When the CG PUSCH transmission is cancelled, the overlapping between the CG PUSCH transmission and PUCCH transmission is resolved: the terminal device 110 may thus first receive the SSB transmission from the network device 120 and then transmit the PUCCH transmission to the network device 120. Solutions of embodiment 10 provide a simple and clear scheduling scheme with respect to coexistence of collision between UL transmissions and collision between UL transmission and DL transmission.

### Embodiment 11

In this embodiment, in case both a potential collision between multiple UL transmissions and a potential collision between DL transmission and UL transmission exist in the same SBFD symbol/slot, all the UL transmissions may be regarded as a whole UL transmission and the collision between the whole UL transmission and the DL transmission may be handled, e.g., based on predefined priority. In other words, in case the DL transmission has a higher priority than the whole UL transmission, all the UL transmissions may be cancelled. In case the DL transmission has a lower priority than the whole UL transmission, the DL transmission may be dropped and the terminal device may resolve the collision between the UL transmissions. For example, if a common priority of the first and second UL transmissions is lower than a priority of the DL transmission, the terminal device 110 may drop the first and second UL transmissions. If the priority of the DL transmission is lower than the common priority of the first and second UL transmissions, the terminal device 110 may stop receiving the DL transmission. In this way, a clear scheme may be provided.

In some alternative embodiments, the terminal device 110 may determine the coexistence of overlapping between multiple transmissions and overlapping between the UL transmission and the DL transmission as an error case. In other words, the terminal device 110 does not expect the coexistence of overlapping between multiple transmissions and overlapping between the UL transmission and the DL transmission happens.

### Embodiment 12

In this embodiment, a behavior for handling collision between transmission direction provided by TDD configuration, e.g., tdd-UL-DL-ConfigurationCommon or tdd-UL-DL-ConfigurationDedicated and transmission direction configured for sub-band in a same TDD symbol/slot may be predefined. For instance, in some embodiments, a behavior for transmission direction determination for the terminal device may be predefined when an UL sub-band is configured in a DL symbol provided by tdd-UL-DL-ConfigurationCommon. The terminal device may then determine to operate reception or transmission in the symbol with SBFD operation based on the predefined behavior.

In some embodiments, the time and frequency resource allocation for the sub-band is configured for terminal device by semi-static configuration, e.g., by RRC configuration. In some alternative embodiments, the time and frequency resource allocation for the sub-band is indicated for terminal device by dynamic indication. e.g., by a UE specific DCI or UE group common DCI.

In some alternative embodiments, a behavior to determine the transmission direction for collision between transmission direction provided by TDD configuration, e.g., tdd-UL-DL-ConfigurationCommon or tdd-UL-DL-ConfigurationDedicated and transmission direction configured for sub-band in a same TDD symbol/slot may be predefined according to Table 2.

TABLE 2

| | | SFI in | |
|---|---|---|---|
| | | DCI 2_0 | |
| conflict | tdd-UL-DL-ConfigurationCommon or | (Flexible | ssb-PositionsInBurst/ |
| signaling | tdd-UL-DL-ConfigurationDedicated | symbol) | PRACH occasion |
| Semi-static | Case 0-0: Tx direction | Case 0-4: | Case 0-6: SSB has higher |
| time/Tx | indication for sub-band will | It is an | priority, UE determines the |
| direction | override the | error case. | symbol as DL symbol and |
| indication | tdd-UL-DL-ConfigurationCommon | Case 0-5: | receives the SSB. |
| for sub-band | Case 0-1: UE determines the Tx | SFI has | Case 0-7: UE doesn't |
| | direction in the set of symbols | higher | expect the SSB overlapped |
| | depends on the dynamic | priority. | with UL sub-band in |
| | scheduling, e.g., gNB schedules a | | frequency domain. |
| | PDSCH in the set of symbols, UE | | Case 0-8: PRACH has |
| | will demines the symbol as DL | | higher priority, UE |
| | symbol. | | determines the symbol as |
| | Case 0-2: For CG | | UL symbol and transmits |
| | PDSCH/PUSCH, if no scheduling | | PRACH occasion. |
| | DCI is received, UE will demines | | Case 0-9: UE doesn't |
| | the symbol as the CG | | expect the PRACH |
| | PDSCH/PUSCH. | | occasion overlapped with |
| | Case 0-3: It is an error case for | | DL sub-band in frequency |
| | UE to receive the conflict | | domain. |
| | signaling provided by | | |
| | tdd-UL-DL-ConfigurationDedicated | | |
| | and sub-band time location. | | |
| Dynamic | Case 1-0: The dynamic | Case 1-3: | Case 1-5: The dynamic |
| time/Tx | sub-band indication will override | error case. | sub-band indication will |
| direction | the slot indication indicated by | Case 1-4: | override the slot indication |
| indication | RRC configuration. | The later | indicated by RRC |
| for sub-band. | Case 1-1: UE determines the Tx | received | configuration. |
| | direction in the set of symbols | dynamic | Case 1-6: error case. |
| | depends on the dynamic | indication | |
| | scheduling, e.g., gNB schedules a | has higher | |
| | PDSCH in the set of symbols, UE | priority. | |
| | will demines the symbol as DL | | |
| | symbol. | | |
| | Case 1-2: CG PUSCH/SPS | | |
| | PDSCH, dynamic time/Tx | | |
| | direction indication has higher | | |
| | priority. | | |

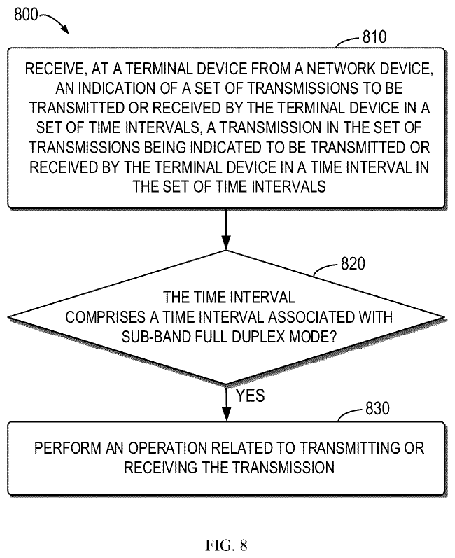

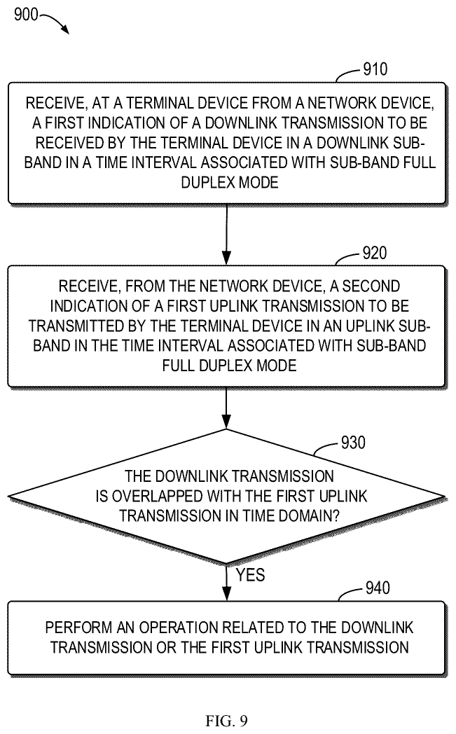

Corresponding to the above processes, embodiments of the present disclosure provide methods of communication implemented at a terminal device and a network device. These methods will be described below with reference to FIGS. 8 and 9.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives, from a network device 120, an indication of a set of transmissions to be transmitted or received by the terminal device 110 in a set of time intervals. A transmission in the set of transmissions is indicated to be transmitted or received by the terminal device in a time interval in the set of time intervals.

At block 820, the terminal device 110 determines whether the time interval comprises a time interval associated with sub-band full duplex mode. If the time interval comprises a time interval associated with sub-band full duplex mode, the method 800 proceeds to block 830.

At block 830, the terminal device 110 performs an operation related to transmitting or receiving the transmission.

In some embodiments, if a frequency resource allocated for the transmission is located within a first sub-band with a first direction in the time interval, the terminal device 110 may determine that the time interval is valid for transmitting or receiving the transmission, the first direction being the same as a direction of the transmission between the terminal device and the network device.

In some embodiments, if the frequency resource is overlapped with a second sub-band with a second direction or overlapped with a guard band between the first sub-band and the second sub-band, the second direction being different from the first direction, the terminal device 110 may determine that the time interval is invalid for transmitting or receiving the transmission.

In some embodiments, if time resource of the transmission is at least partially overlapped with a time interval invalid for transmitting or receiving the transmission, the terminal device 110 may cancel the transmission.

In some embodiments, if a first part of time resource of the transmission is overlapped with a time interval invalid for transmitting or receiving the transmission and a second part of the time resource of the transmission is overlapped with a time interval associated with a half-duplex mode, the terminal device 110 may transmit or receive part of the transmission located in the time interval associated with a half-duplex mode.

In some embodiments, if the frequency resource is overlapped with a second sub-band with a second direction or overlapped with a guard band between the first sub-band and the second sub-band, the second direction being different from the first direction, the terminal device 110 may determine the set of transmissions as an error case.

In some embodiments, a bandwidth part (BWP) available for the time interval may comprise at least a first sub-band with a first direction and a second sub-band with a second direction in the time interval, the first direction being the same as a direction of the transmission between the terminal device and the network device, the second direction being opposite to the first direction.

In some embodiments, the terminal device 110 may determine a frequency resource allocation of the transmission based on a reference BWP comprising the first sub-band; and transmit or receive the transmission in the time interval based on the frequency resource allocation.

In some embodiments, the terminal device 110 may determine a frequency resource allocation of the transmission based on a BWP available for the time interval. The BWP comprises a first sub-band with a first direction in the time interval. The first direction is the same as a direction of the transmission between the terminal device and the network device. The terminal device 110 may transmit or receive the transmission in the time interval based on the frequency resource allocation.

In some embodiments, the terminal device 110 may receive, from the network device, information of frequency resource allocation of the transmission, the information comprising a first frequency resource indicator for a time interval associated with half duplex mode and a second frequency resource indicator for the time interval associated with sub-band full duplex mode.

In some embodiments, the terminal device 110 may determine a frequency resource allocation of the transmission based on the second frequency resource indicator; and transmit or receive the transmission in the time interval based on the frequency resource allocation.

In some embodiments, the terminal device 110 may receive, from the network device, an indication whether the set of transmissions are to be transmitted or received in time intervals associated with half duplex mode or in time intervals associated with sub-band full duplex mode by the terminal device.

In some embodiments, if the set of transmissions are to be transmitted or received in time intervals associated with sub-band full duplex mode based on the indication, the terminal device 110 may transmit or receive the transmission in the time interval. If the set of transmissions are to be transmitted or received in time intervals associated with half duplex mode based on the indication, the terminal device 110 may skip the time interval associated with sub-band full duplex mode and postpone transmitting or receiving the transmission to a subsequent time interval associated with half duplex mode.

In some embodiments, the indication may comprise at least one of: an explicit indication in downlink control information (DCI), a type of a first time interval on which a first transmission in the set of transmissions is transmitted or received by the terminal device based on the DCI, a frequency resource allocation in the DCI, a first index of a first BWP in the DCI, the first BWP corresponding to a time interval associated with sub-band full duplex mode, and a second index of a second BWP in the DCI, the second BWP corresponding to a time interval associated with half duplex mode.

In some embodiments, the indication may comprise at least one of: presence or absence of sub-band information in an activation DCI, a type of a first time interval on which a first transmission in the set of transmissions is transmitted or received by the terminal device based on the activation DCI, a frequency resource allocation in the activation DCI, a first configured grant configuration index in a radio resource control (RRC) configuration, the first configured grant configuration index corresponding to a time interval associated with sub-band full duplex mode, and a second configured grant configuration index in the RRC configuration, the second configured grant configuration index corresponding to a time interval associated with half duplex mode.

In some embodiments, in response to receiving an indication that time intervals associated with sub-band full duplex mode are valid time intervals for the set of transmissions, the terminal device 110 may transmit or receive the transmission in the time interval. In response to receiving an indication that time intervals associated with sub-band full duplex mode are invalid time intervals for the set of transmissions, the terminal device 110 may cancel the transmission or postpone transmitting or receiving the transmission to a subsequent time interval associated with half duplex mode.

In some embodiments, if the time interval is a time interval associated with sub-band full duplex mode and a further time interval in the set of time intervals is a time interval associated with half duplex mode and that a further transmission in the set of transmissions is indicated to be transmitted or received by the terminal device in the further time interval, the terminal device 110 may determine the set of transmissions as an error case.

In some embodiments, the set of transmissions are multiple repetitions of the transmission.

In some embodiments, the terminal device 110 may receive, from the network device, a frequency hopping indication of the set of transmissions; and transmit a plurality of transmissions in the set of transmissions using a first frequency resource and a second frequency resource alternately based on the frequency hopping indication.

In some embodiments, if a first hop of transmission is overlapped with a time interval associated with half-duplex mode and a second hop of transmission is overlapped with the time interval associated with sub-band full duplex mode, the terminal device 110 may cancel transmitting the second hop of the transmission if the time interval associated with sub-band full duplex mode is invalid for transmitting the second hop of the transmission; or postpone transmitting the second hop of the transmission to a subsequent time interval associated with half duplex mode.

In some embodiments, if a second hop of transmission is indicated to be transmitted by the terminal device using the second frequency resource, the terminal device 110 may determine the second frequency resource based on the first frequency resource and a first frequency offset associated with the time interval associated with sub-band full duplex mode. The first frequency offset is different from a second frequency offset associated with a time interval associated with half duplex mode. The terminal device 110 may transmit the second hop of transmission using the second frequency resource in the time interval.

With the method of FIG. 8, a sub-band non-overlapping full duplex scheme with respect to resource allocation may be well supported.

FIG. 9 illustrates another example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 receives, from a network device 120, a first indication of a downlink transmission to be received by the terminal device in a downlink sub-band in a time interval associated with sub-band full duplex mode.

At block 920, the terminal device 110 receives, from a network device 120, a second indication of a first uplink transmission to be transmitted by the terminal device in an uplink sub-band in the time interval associated with sub-band full duplex mode.

At block 930, the terminal device 110 determines whether the downlink transmission is overlapped with the first uplink transmission in time domain. If the downlink transmission is overlapped with the first uplink transmission in time domain, the method 900 proceeds to block 940.

At block 940, the terminal device 110 performs an operation related to the downlink transmission or the first uplink transmission.

In some embodiments, if a priority of the first uplink transmission is lower than a priority of the downlink transmission, the terminal device 110 may drop the first uplink transmission. If a priority of the downlink transmission is lower than a priority of the first uplink transmission, the terminal device 110 may stop receiving the downlink transmission.

In some embodiments, the downlink transmission may be a Semi Persistent Scheduling Physical Downlink Shared Channel (SPS PDSCH). The terminal device 110 may stop receiving the SPS PDSCH.

In some embodiments, if the first uplink transmission is a Physical Random Access Channel (PRACH), the terminal device 110 may stop receiving the downlink transmission.

In some embodiments, if the downlink transmission is to at least partially overlap with the uplink sub-band or a guard band between the uplink sub-band and the downlink sub-band, the terminal device 110 may cancel the downlink transmission: or determine part of the downlink transmission located in the downlink sub-band as a target downlink transmission.

In some embodiments, if there is no overlapping between the downlink transmission and the uplink sub-band and that the downlink transmission is to overlap with the first uplink transmission in time domain, the terminal device 110 may resolve a potential collision between the downlink transmission and the first uplink transmission.

In some embodiments, if the downlink transmission is to overlap with the first uplink transmission in time domain, the terminal device 110 may determine one of the first uplink transmission and the downlink transmission as a target transmission to resolve a potential collision between the first uplink transmission and the downlink transmission.

In some embodiments, if there is no potential collision between the downlink transmission and the first uplink transmission and that the downlink transmission is to at least partially overlap with the uplink sub-band, the terminal device 110 may cancel the downlink transmission: or receive part of the downlink transmission located in the downlink sub-band.

In some embodiments, the terminal device 110 may receive, from the network device, a third indication of a second uplink transmission to be transmitted by the terminal device in the uplink sub-band in the time interval associated with sub-band full duplex mode.

In some embodiments, if the second uplink transmission is to overlap with the first uplink transmission in time domain, the terminal device 110 may determine a target uplink transmission based on the first uplink transmission and the second uplink transmission to resolve a potential collision between the first uplink transmission and the second uplink transmission; and resolve a potential collision between the downlink transmission and the target uplink transmission.

In some embodiments, the target uplink transmission may be one of: the first uplink transmission, the second uplink transmission, or an adjusted first uplink transmission determined by multiplexing a portion of the second uplink transmission in the first uplink transmission.

In some embodiments, if the second uplink transmission is to overlap with the first uplink transmission in time domain, the terminal device 110 may determine one of the first uplink transmission and the downlink transmission as a target transmission to resolve a potential collision between the first uplink transmission and the downlink transmission; and resolve a potential collision between the target transmission and the second uplink transmission.

In some embodiments, if an overlapping between the downlink transmission and the first uplink transmission in time domain is earlier than an overlapping between the first and second uplink transmissions in time domain, the terminal device 110 may determine one of the first uplink transmission and the downlink transmission as a target transmission to resolve a potential collision between the downlink transmission and the first uplink transmission. If the overlapping between the first and second uplink transmissions in time domain is earlier than the overlapping between the downlink transmission and the first uplink transmission in time domain, the terminal device 110 may determine a target uplink transmission based on the first uplink transmission and the second uplink transmission to resolve a potential collision between the first and second uplink transmissions.

In some embodiments, if a common priority of the first and second uplink transmissions is lower than a priority of the downlink transmission, the terminal device 110 may drop the first and second uplink transmissions. If the priority of the downlink transmission is lower than the common priority of the first and second uplink transmissions, the terminal device 110 may stop receiving the downlink transmission.

In some embodiments, the terminal device 110 may determine coexistence of overlapping between the first and second uplink transmissions and overlapping between the first uplink transmission and the downlink transmission as an error case.

With the method of FIG. 9, a sub-band non-overlapping full duplex scheme with respect to potential transmission collisions may be supported.

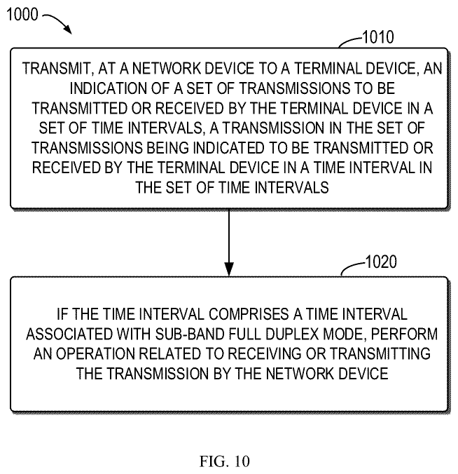

FIG. 10 illustrates an example method 1000 of communication implemented at a network device in accordance with some embodiments of the present disclosure. For example, the method 1000 may be performed at the network device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the network device 120 transmits, to a terminal device 110, an indication of a set of transmissions to be transmitted or received by the terminal device in a set of time intervals. A transmission in the set of transmissions is indicated to be transmitted or received by the terminal device in a time interval in the set of time intervals.

At block 1020, if the time interval comprises a time interval associated with sub-band full duplex mode, the network device 120 performs an operation related to receiving or transmitting the transmission by the network device.

In some embodiments, if a frequency resource allocated for the transmission is located within a first sub-band with a first direction in the time interval, the network device 120 may determine that the time interval is valid for receiving or transmitting the transmission, the first direction being the same as a direction of the transmission between the terminal device and the network device.

In some embodiments, if the frequency resource is overlapped with a second sub-band with a second direction or overlapped with a guard band between the first sub-band and the second sub-band, the second direction being different from the first direction, the network device 120 may determine that the time interval is invalid for receiving or transmitting the transmission.

In some embodiments, if time resource of the transmission is at least partially overlapped with a time interval invalid for receiving or transmitting the transmission, the network device 120 may cancel the transmission.

In some embodiments, if a first part of time resource of the transmission is overlapped with a time interval invalid for receiving or transmitting the transmission and a second part of the time resource of the transmission is overlapped with a time interval associated with a half-duplex mode, the network device 120 may receive or transmit part of the transmission located in the time interval associated with a half-duplex mode.

In some embodiments, a bandwidth part (BWP) available for the time interval may comprise at least a first sub-band with a first direction and a second sub-band with a second direction in the time interval, the first direction being the same as a direction of the transmission between the terminal device and the network device, the second direction being opposite to the first direction.

In some embodiments, the network device 120 may transmit, to the terminal device 110, an indication of a frequency resource allocation of the transmission based on a reference BWP comprising the first sub-band; and receive or transmit the transmission in the time interval based on the frequency resource allocation.

In some embodiments, the network device 120 may transmit, to the terminal device 110, an indication of a frequency resource allocation of the transmission based on a BWP available for the time interval. The BWP comprises a first sub-band with a first direction in the time interval. The first direction is the same as a direction of the transmission between the terminal device and the network device. The network device 120 may receive or transmit the transmission in the time interval based on the frequency resource allocation.

In some embodiments, the network device 120 may transmit, to the terminal device, information of frequency resource allocation of the transmission, the information comprising a first frequency resource indicator for a time interval associated with half duplex mode and a second frequency resource indicator for the time interval associated with sub-band full duplex mode.

In some embodiments, the network device 120 may transmit, to the terminal device 110, an indication of a frequency resource allocation of the transmission based on the second frequency resource indicator; and receive or transmit the transmission in the time interval based on the frequency resource allocation.

In some embodiments, the network device 120 may transmit, to the terminal device, an indication whether the set of transmissions are to be received or transmitted in time intervals associated with half duplex mode or in time intervals associated with sub-band full duplex mode by the terminal device.

In some embodiments, in response to the set of transmissions being to be received or transmitted in time intervals associated with sub-band full duplex mode, the network device 120 may receive or transmit the transmission in the time interval. In response to the set of transmissions being to be received or transmitted in time intervals associated with half duplex mode, the network device 120 may skip the time interval associated with sub-band full duplex mode and postpone receiving or transmitting the transmission to a subsequent time interval associated with half duplex mode.

In some embodiments, the indication may comprise at least one of: an explicit indication in downlink control information (DCI), a type of a first time interval on which a first transmission in the set of transmissions is transmitted or received by the terminal device based on the DCI, a frequency resource allocation in the DCI, a first index of a first BWP in the DCI, the first BWP corresponding to a time interval associated with sub-band full duplex mode, and a second index of a second BWP in the DCI, the second BWP corresponding to a time interval associated with half duplex mode.

In some embodiments, the indication may comprise at least one of: presence or absence of sub-band information in an activation DCI, a type of a first time interval on which a first transmission in the set of transmissions is transmitted or received by the terminal device based on the activation DCI, a frequency resource allocation in the activation DCI, a first configured grant configuration index in a radio resource control (RRC) configuration, the first configured grant configuration index corresponding to a time interval associated with sub-band full duplex mode, and a second configured grant configuration index in the RRC configuration, the second configured grant configuration index corresponding to a time interval associated with half duplex mode.

In some embodiments, if that time intervals associated with sub-band full duplex mode are valid time intervals for the set of transmissions, the network device 120 may receive or transmit the transmission in the time interval. If time intervals associated with sub-band full duplex mode are invalid time intervals for the set of transmissions, the network device 120 may cancel the transmission or postponing receiving or transmitting the transmission to a subsequent time interval associated with half duplex mode.

In some embodiments, the set of transmissions are multiple repetitions of the transmission.

In some embodiments, the network device 120 may transmit, to the terminal device, a frequency hopping indication of the set of transmissions; and receive a plurality of transmissions in the set of transmissions using a first frequency resource and a second frequency resource alternately based on the frequency hopping indication.

In some embodiments, if a first hop of transmission is overlapped with a time interval associated with half-duplex mode and a second hop of transmission is overlapped with the time interval associated with sub-band full duplex mode, the network device 120 may cancel receiving the second hop of the transmission if the time interval associated with sub-band full duplex mode is invalid for receiving the second hop of the transmission: or postpone receiving the second hop of the transmission to a subsequent time interval associated with half duplex mode.

In some embodiments, if a second hop of transmission is indicated to be transmitted by the terminal device using the second frequency resource, the network device 120 may transmit, to the terminal device 110, an indication of the second frequency resource based on the first frequency resource and a first frequency offset associated with the time interval associated with sub-band full duplex mode. The first frequency offset is different from a second frequency offset associated with a time interval associated with half duplex mode. The network device 120 may receive the second hop of transmission using the second frequency resource in the time interval.

With the method of FIG. 10, a sub-band non-overlapping full duplex scheme with respect to resource allocation may be well supported.

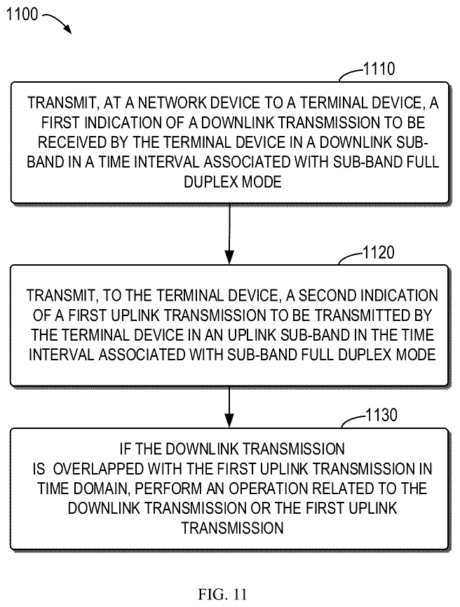

FIG. 11 illustrates another example method 1100 of communication implemented at a network device in accordance with some embodiments of the present disclosure. For example, the method 1100 may be performed at the network device 120 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the network device 120 transmits, to a terminal device 110, a first indication of a downlink transmission to be received by the terminal device in a downlink sub-band in a time interval associated with sub-band full duplex mode.

At block 1120, the network device 120 transmits, to the terminal device, a second indication of a first uplink transmission to be transmitted by the terminal device in an uplink sub-band in the time interval associated with sub-band full duplex mod.

At block 1130, if the downlink transmission is overlapped with the first uplink transmission in time domain, the network device 120 performs an operation related to the downlink transmission or the first uplink transmission.

In some embodiments, if a priority of the first uplink transmission is lower than a priority of the downlink transmission, the network device 120 may stop receiving the first uplink transmission. If a priority of the downlink transmission is lower than a priority of the first uplink transmission, the network device 120 may drop the downlink transmission.

In some embodiments, the downlink transmission may be a Semi Persistent Scheduling Physical Downlink Shared Channel (SPS PDSCH). The network device 120 may drop the SPS PDSCH.

In some embodiments, if the first uplink transmission is a Physical Random Access Channel (PRACH), the network device 120 may drop the downlink transmission.

In some embodiments, if the downlink transmission is to at least partially overlap with the uplink sub-band or a guard band between the uplink sub-band and the downlink sub-band, the network device 120 may cancel the downlink transmission: or determine part of the downlink transmission located in the downlink sub-band as a target downlink transmission.

In some embodiments, if there is no overlapping between the downlink transmission and the uplink sub-band and that the downlink transmission is to overlap with the first uplink transmission in time domain, the network device 120 may resolve a potential collision between the downlink transmission and the first uplink transmission.

In some embodiments, if the downlink transmission is to overlap with the first uplink transmission in time domain, the network device 120 may determine one of the first uplink transmission and the downlink transmission as a target transmission to resolve a potential collision between the first uplink transmission and the downlink transmission.

In some embodiments, if there is no potential collision between the downlink transmission and the first uplink transmission and that the downlink transmission is to at least partially overlap with the uplink sub-band, the network device 120 may cancel the downlink transmission: or transmit part of the downlink transmission located in the downlink sub-band.

In some embodiments, the network device 120 may transmit, to the terminal device, a third indication of a second uplink transmission to be transmitted by the terminal device in the uplink sub-band in the time interval associated with sub-band full duplex mode.

In some embodiments, if the second uplink transmission is to overlap with the first uplink transmission in time domain, the network device 120 may determine a target uplink transmission based on the first uplink transmission and the second uplink transmission to resolve a potential collision between the first uplink transmission and the second uplink transmission; and resolve a potential collision between the downlink transmission and the target uplink transmission.

In some embodiments, the target uplink transmission may be one of: the first uplink transmission, the second uplink transmission, or an adjusted first uplink transmission determined by multiplexing a portion of the second uplink transmission in the first uplink transmission.

In some embodiments, if the second uplink transmission is to overlap with the first uplink transmission in time domain, the network device 120 may determine one of the first uplink transmission and the downlink transmission as a target transmission to resolve a potential collision between the first uplink transmission and the downlink transmission; and resolve a potential collision between the target transmission and the second uplink transmission.

In some embodiments, if an overlapping between the downlink transmission and the first uplink transmission in time domain is earlier than an overlapping between the first and second uplink transmissions in time domain, the network device 120 may determine one of the first uplink transmission and the downlink transmission as a target transmission to resolve a potential collision between the downlink transmission and the first uplink transmission. If the overlapping between the first and second uplink transmissions in time domain is earlier than the overlapping between the downlink transmission and the first uplink transmission in time domain, the network device 120 may determine a target uplink transmission based on the first uplink transmission and the second uplink transmission to resolve a potential collision between the first and second uplink transmissions.

In some embodiments, if a common priority of the first and second uplink transmissions is lower than a priority of the downlink transmission, the network device 120 may stop receiving the first and second uplink transmissions. If the priority of the downlink transmission is lower than the common priority of the first and second uplink transmissions, the network device 120 may drop the downlink transmission.

With the method of FIG. 11, a sub-band non-overlapping full duplex scheme with respect to potential transmission collisions may be supported.

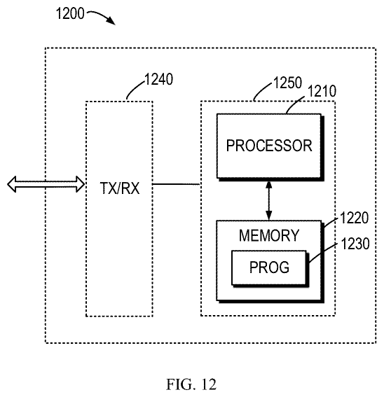

FIG. 12 is a simplified block diagram of a device 1200 that is suitable for implementing embodiments of the present disclosure. The device 1200 can be considered as a further example implementation of the terminal device 110 or the network device 120 as shown in FIG. 1. Accordingly, the device 1200 can be implemented at or as at least a part of the terminal device 110 or the network device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 910 stores at least a part of a program 1230. The TX/RX 1240 is for bidirectional communications. The TX/RX 1240 has at least one antenna to facilitate communication, though in practice an Access Node mentioned in this application may have several ones.

The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 1 to 7D. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory; as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a terminal device comprises circuitry configured to perform method 800. In some embodiments, a terminal device comprises circuitry configured to perform method 900. In some embodiments, a network device comprises circuitry configured to perform method 1000. In some embodiments, a network device comprises circuitry configured to perform method 1100.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7D. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

In summary; embodiments of the present disclosure may provide the following solutions.

A method of communication comprises: receiving, at a terminal device from a network device, an indication of a set of transmissions to be transmitted or received by the terminal device in a set of time intervals, a transmission in the set of transmissions being indicated to be transmitted or received by the terminal device in a time interval in the set of time intervals; and in response to determining that the time interval comprises a time interval associated with sub-band full duplex mode, performing an operation related to transmitting or receiving the transmission.

In one embodiment, performing the operation comprises: in response to determining that a frequency resource allocated for the transmission is located within a first sub-band with a first direction in the time interval, determining that the time interval is valid for transmitting or receiving the transmission, the first direction being the same as a direction of the transmission between the terminal device and the network device.

In one embodiment, performing the operation further comprises: in response to determining that the frequency resource is overlapped with a second sub-band with a second direction or overlapped with a guard band between the first sub-band and the second sub-band, the second direction being different from the first direction, determining that the time interval is invalid for transmitting or receiving the transmission.

In one embodiment, performing the operation further comprises: in response to determining that time resource of the transmission is at least partially overlapped with a time interval invalid for transmitting or receiving the transmission, cancelling the transmission.

In one embodiment, performing the operation further comprises: in response to determining that a first part of time resource of the transmission is overlapped with a time interval invalid for transmitting or receiving the transmission and a second part of the time resource of the transmission is overlapped with a time interval associated with a half-duplex mode, transmitting or receiving part of the transmission located in the time interval associated with a half-duplex mode.

In one embodiment, performing the operation further comprises: in response to determining that the frequency resource is overlapped with a second sub-band with a second direction or overlapped with a guard band between the first sub-band and the second sub-band, the second direction being different from the first direction, determining the set of transmissions as an error case.

In one embodiment, a bandwidth part (BWP) available for the time interval comprises at least a first sub-band with a first direction and a second sub-band with a second direction in the time interval, the first direction being the same as a direction of the transmission between the terminal device and the network device, the second direction being opposite to the first direction.

In one embodiment, performing the operation comprises: determining a frequency resource allocation of the transmission based on a reference BWP comprising the first sub-band; and transmitting or receiving the transmission in the time interval based on the frequency resource allocation.

In one embodiment, performing the operation comprises: determining a frequency resource allocation of the transmission based on a BWP available for the time interval, the BWP comprising a first sub-band with a first direction in the time interval, the first direction being the same as a direction of the transmission between the terminal device and the network device; and transmitting or receiving the transmission in the time interval based on the frequency resource allocation.

In one embodiment, the method as above further comprises: receiving, from the network device, information of frequency resource allocation of the transmission, the information comprising a first frequency resource indicator for a time interval associated with half duplex mode and a second frequency resource indicator for the time interval associated with sub-band full duplex mode.

In one embodiment, performing the operation comprises: determining a frequency resource allocation of the transmission based on the second frequency resource indicator; and transmitting or receiving the transmission in the time interval based on the frequency resource allocation.

In one embodiment, the method as above further comprises: receiving, from the network device, an indication whether the set of transmissions are to be transmitted or received in time intervals associated with half duplex mode or in time intervals associated with sub-band full duplex mode by the terminal device.

In one embodiment, performing the operation comprises: in response to determining that the set of transmissions are to be transmitted or received in time intervals associated with sub-band full duplex mode based on the indication, transmitting or receiving the transmission in the time interval; and in response to determining that the set of transmissions are to be transmitted or received in time intervals associated with half duplex mode based on the indication, skipping the time interval associated with sub-band full duplex mode and postponing transmitting or receiving the transmission to a subsequent time interval associated with half duplex mode.

In one embodiment, the indication comprises at least one of: an explicit indication in downlink control information (DCI), a type of a first time interval on which a first transmission in the set of transmissions is transmitted or received by the terminal device based on the DCI, a frequency resource allocation in the DCI, a first index of a first BWP in the DCI, the first BWP corresponding to a time interval associated with sub-band full duplex mode, and a second index of a second BWP in the DCI, the second BWP corresponding to a time interval associated with half duplex mode.

In one embodiment, the indication comprises at least one of: presence or absence of sub-band information in an activation DCI, a type of a first time interval on which a first transmission in the set of transmissions is transmitted or received by the terminal device based on the activation DCI, a frequency resource allocation in the activation DCI, a first configured grant configuration index in a radio resource control (RRC) configuration, the first configured grant configuration index corresponding to a time interval associated with sub-band full duplex mode, and a second configured grant configuration index in the RRC configuration, the second configured grant configuration index corresponding to a time interval associated with half duplex mode.

In one embodiment, performing the operation comprises: in response to receiving an indication that time intervals associated with sub-band full duplex mode are valid time intervals for the set of transmissions, transmitting or receiving the transmission in the time interval; and in response to receiving an indication that time intervals associated with sub-band full duplex mode are invalid time intervals for the set of transmissions, cancelling the transmission or postponing transmitting or receiving the transmission to a subsequent time interval associated with half duplex mode.

In one embodiment, performing the operation comprises: in response to determining that the time interval is a time interval associated with sub-band full duplex mode and a further time interval in the set of time intervals is a time interval associated with half duplex mode and that a further transmission in the set of transmissions is indicated to be transmitted or received by the terminal device in the further time interval, determining the set of transmissions as an error case.

In one embodiment, the set of transmissions are multiple repetitions of the transmission.

In one embodiment, the method as above further comprises: receiving, from the network device, a frequency hopping indication of the set of transmissions; and transmitting a plurality of transmissions in the set of transmissions using a first frequency resource and a second frequency resource alternately based on the frequency hopping indication.

In one embodiment, performing the operation comprises: in response to determining that a first hop of transmission is overlapped with a time interval associated with half-duplex mode and a second hop of transmission is overlapped with the time interval associated with sub-band full duplex mode, cancelling transmitting the second hop of the transmission if the time interval associated with sub-band full duplex mode is invalid for transmitting the second hop of the transmission: or postponing transmitting the second hop of the transmission to a subsequent time interval associated with half duplex mode.

In one embodiment, performing the operation comprises: in response to determining that a second hop of transmission is indicated to be transmitted by the terminal device using the second frequency resource, determining the second frequency resource based on the first frequency resource and a first frequency offset associated with the time interval associated with sub-band full duplex mode, the first frequency offset being different from a second frequency offset associated with a time interval associated with half duplex mode; and transmitting the second hop of transmission using the second frequency resource in the time interval.

A method of communication comprises: receiving, at a terminal device from a network device, a first indication of a downlink transmission to be received by the terminal device in a downlink sub-band in a time interval associated with sub-band full duplex mode; receiving, from the network device, a second indication of a first uplink transmission to be transmitted by the terminal device in an uplink sub-band in the time interval associated with sub-band full duplex mode; and in response to determining that the downlink transmission is overlapped with the first uplink transmission in time domain, performing an operation related to the downlink transmission or the first uplink transmission.

In one embodiment, performing the operation comprises: in response to determining that a priority of the first uplink transmission is lower than a priority of the downlink transmission, dropping the first uplink transmission; and in response to determining that a priority of the downlink transmission is lower than a priority of the first uplink transmission, stopping receiving the downlink transmission.

In one embodiment, the downlink transmission is a Semi Persistent Scheduling Physical Downlink Shared Channel (SPS PDSCH), wherein performing the operation comprises: stopping receiving the SPS PDSCH.

In one embodiment, performing the operation comprises: in response to determining that the first uplink transmission is a Physical Random Access Channel (PRACH), stopping receiving the downlink transmission.

In one embodiment, the method as above further comprises: in response to determining that the downlink transmission is to at least partially overlap with the uplink sub-band or a guard band between the uplink sub-band and the downlink sub-band, cancelling the downlink transmission: or determining part of the downlink transmission located in the downlink sub-band as a target downlink transmission.

In one embodiment, performing the operation comprises: in response to determining that there is no overlapping between the downlink transmission and the uplink sub-band and that the downlink transmission is to overlap with the first uplink transmission in time domain, resolving a potential collision between the downlink transmission and the first uplink transmission.

In one embodiment, performing the operation comprises: in response to determining that the downlink transmission is to overlap with the first uplink transmission in time domain, determining one of the first uplink transmission and the downlink transmission as a target transmission to resolve a potential collision between the first uplink transmission and the downlink transmission.

In one embodiment, the method as above further comprises: in response to determining that there is no potential collision between the downlink transmission and the first uplink transmission and that the downlink transmission is to at least partially overlap with the uplink sub-band, cancelling the downlink transmission: or receiving part of the downlink transmission located in the downlink sub-band.

In one embodiment, the method as above further comprises: receiving, from the network device, a third indication of a second uplink transmission to be transmitted by the terminal device in the uplink sub-band in the time interval associated with sub-band full duplex mode.

In one embodiment, the method as above further comprises: in response to determining that the second uplink transmission is to overlap with the first uplink transmission in time domain, determining a target uplink transmission based on the first uplink transmission and the second uplink transmission to resolve a potential collision between the first uplink transmission and the second uplink transmission; and resolving a potential collision between the downlink transmission and the target uplink transmission.

In one embodiment, the target uplink transmission is one of: the first uplink transmission, the second uplink transmission, or an adjusted first uplink transmission determined by multiplexing a portion of the second uplink transmission in the first uplink transmission.

In one embodiment, performing the operation comprises: in response to determining that the second uplink transmission is to overlap with the first uplink transmission in time domain, determining one of the first uplink transmission and the downlink transmission as a target transmission to resolve a potential collision between the first uplink transmission and the downlink transmission; and resolving a potential collision between the target transmission and the second uplink transmission.

In one embodiment, performing the operation comprises: in response to determining that an overlapping between the downlink transmission and the first uplink transmission in time domain is earlier than an overlapping between the first and second uplink transmissions in time domain, determining one of the first uplink transmission and the downlink transmission as a target transmission to resolve a potential collision between the downlink transmission and the first uplink transmission; and in response to determining that the overlapping between the first and second uplink transmissions in time domain is earlier than the overlapping between the downlink transmission and the first uplink transmission in time domain, determining a target uplink transmission based on the first uplink transmission and the second uplink transmission to resolve a potential collision between the first and second uplink transmissions.

In one embodiment, performing the operation comprises: in response to determining that a common priority of the first and second uplink transmissions is lower than a priority of the downlink transmission, dropping the first and second uplink transmissions; and in response to determining that the priority of the downlink transmission is lower than the common priority of the first and second uplink transmissions, stopping receiving the downlink transmission.

In one embodiment, the method as above further comprises: determining coexistence of overlapping between the first and second uplink transmissions and overlapping between the first uplink transmission and the downlink transmission as an error case.

A method of communication comprises: transmitting, at a network device to a terminal device, an indication of a set of transmissions to be transmitted or received by the terminal device in a set of time intervals, a transmission in the set of transmissions being indicated to be transmitted or received by the terminal device in a time interval in the set of time intervals; and in response to the time interval comprising a time interval associated with sub-band full duplex mode, performing an operation related to receiving or transmitting the transmission by the network device.

In one embodiment, performing the operation comprises: in response to a frequency resource allocated for the transmission being located within a first sub-band with a first direction in the time interval, determining that the time interval is valid for receiving or transmitting the transmission, the first direction being the same as a direction of the transmission between the terminal device and the network device.

In one embodiment, performing the operation further comprises: in response to the frequency resource being overlapped with a second sub-band with a second direction or overlapped with a guard band between the first sub-band and the second sub-band, the second direction being different from the first direction, determining that the time interval is invalid for receiving or transmitting the transmission.

In one embodiment, performing the operation further comprises: in response to time resource of the transmission being at least partially overlapped with a time interval invalid for receiving or transmitting the transmission, cancelling the transmission.

In one embodiment, performing the operation further comprises: in response to a first part of time resource of the transmission being overlapped with a time interval invalid for receiving or transmitting the transmission and a second part of the time resource of the transmission being overlapped with a time interval associated with a half-duplex mode, receiving or transmitting part of the transmission located in the time interval associated with a half-duplex mode.

In one embodiment, a bandwidth part (BWP) available for the time interval comprises at least a first sub-band with a first direction and a second sub-band with a second direction in the time interval, the first direction being the same as a direction of the transmission between the terminal device and the network device, the second direction being opposite to the first direction.

In one embodiment, performing the operation comprises: transmitting, to the terminal device, an indication of a frequency resource allocation of the transmission based on a reference BWP comprising the first sub-band; and receiving or transmitting the transmission in the time interval based on the frequency resource allocation.

In one embodiment, performing the operation comprises: transmitting, to the terminal device, an indication of a frequency resource allocation of the transmission based on a BWP available for the time interval, the BWP comprising a first sub-band with a first direction in the time interval, the first direction being the same as a direction of the transmission between the terminal device and the network device; and receiving or transmitting the transmission in the time interval based on the frequency resource allocation.

In one embodiment, the method as above further comprises: transmitting, to the terminal device, information of frequency resource allocation of the transmission, the information comprising a first frequency resource indicator for a time interval associated with half duplex mode and a second frequency resource indicator for the time interval associated with sub-band full duplex mode.

In one embodiment, performing the operation comprises: transmitting, to the terminal device, an indication of a frequency resource allocation of the transmission based on the second frequency resource indicator; and receiving or transmitting the transmission in the time interval based on the frequency resource allocation.

In one embodiment, the method as above further comprises: transmitting, to the terminal device, an indication whether the set of transmissions are to be received or transmitted in time intervals associated with half duplex mode or in time intervals associated with sub-band full duplex mode by the terminal device.

In one embodiment, performing the operation comprises: in response to the set of transmissions being to be received or transmitted in time intervals associated with sub-band full duplex mode, receiving or transmitting the transmission in the time interval; and in response to the set of transmissions being to be received or transmitted in time intervals associated with half duplex mode, skipping the time interval associated with sub-band full duplex mode and postponing receiving or transmitting the transmission to a subsequent time interval associated with half duplex mode.

In one embodiment, the indication comprises at least one of: an explicit indication in downlink control information (DCI), a type of a first time interval on which a first transmission in the set of transmissions is transmitted or received by the terminal device based on the DCI, a frequency resource allocation in the DCI, a first index of a first BWP in the DCI, the first BWP corresponding to a time interval associated with sub-band full duplex mode, and a second index of a second BWP in the DCI, the second BWP corresponding to a time interval associated with half duplex mode.

In one embodiment, the indication comprises at least one of: presence or absence of sub-band information in an activation DCI, a type of a first time interval on which a first transmission in the set of transmissions is transmitted or received by the terminal device based on the activation DCI, a frequency resource allocation in the activation DCI, a first configured grant configuration index in a radio resource control (RRC) configuration, the first configured grant configuration index corresponding to a time interval associated with sub-band full duplex mode, and a second configured grant configuration index in the RRC configuration, the second configured grant configuration index corresponding to a time interval associated with half duplex mode.

In one embodiment, performing the operation comprises: in response to time intervals associated with sub-band full duplex mode being valid time intervals for the set of transmissions, receiving or transmitting the transmission in the time interval; and in response to time intervals associated with sub-band full duplex mode being invalid time intervals for the set of transmissions, cancelling the transmission or postponing receiving or transmitting the transmission to a subsequent time interval associated with half duplex mode.

In one embodiment, the set of transmissions are multiple repetitions of the transmission.

In one embodiment, the method as above further comprises: transmitting, to the terminal device, a frequency hopping indication of the set of transmissions; and receiving a plurality of transmissions in the set of transmissions using a first frequency resource and a second frequency resource alternately based on the frequency hopping indication.

In one embodiment, performing the operation comprises: in response to a first hop of transmission being overlapped with a time interval associated with half-duplex mode and a second hop of transmission being overlapped with the time interval associated with sub-band full duplex mode, cancelling receiving the second hop of the transmission if the time interval associated with sub-band full duplex mode is invalid for receiving the second hop of the transmission: or postponing receiving the second hop of the transmission to a subsequent time interval associated with half duplex mode.

In one embodiment, performing the operation comprises: in response to a second hop of transmission being to be transmitted by the terminal device using the second frequency resource, transmitting, to the terminal device, an indication of a first frequency offset associated with the time interval associated with sub-band full duplex mode, the second frequency resource being determined based on the first frequency resource and the first frequency offset, the first frequency offset being different from a second frequency offset associated with a time interval associated with half duplex mode; and receiving the second hop of transmission using the second frequency resource in the time interval.

A method of communication comprises: transmitting, at a network device to a terminal device, a first indication of a downlink transmission to be received by the terminal device in a downlink sub-band in a time interval associated with sub-band full duplex mode; transmitting, to the terminal device, a second indication of a first uplink transmission to be transmitted by the terminal device in an uplink sub-band in the time interval associated with sub-band full duplex mode; and in response to the downlink transmission being overlapped with the first uplink transmission in time domain, performing an operation related to the downlink transmission or the first uplink transmission.

In one embodiment, performing the operation comprises: in response to a priority of the first uplink transmission being lower than a priority of the downlink transmission, stop receiving the first uplink transmission; and in response to a priority of the downlink transmission being lower than a priority of the first uplink transmission, dropping the downlink transmission.

In one embodiment, the downlink transmission is a Semi Persistent Scheduling Physical Downlink Shared Channel (SPS PDSCH), wherein performing the operation comprises: dropping the SPS PDSCH.

In one embodiment, performing the operation comprises: in response to the first uplink transmission being a Physical Random Access Channel (PRACH), dropping the downlink transmission.

In one embodiment, the method as above further comprises: in response to the downlink transmission being to at least partially overlap with the uplink sub-band or a guard band between the uplink sub-band and the downlink sub-band, cancelling the downlink transmission: or determining part of the downlink transmission located in the downlink sub-band as a target downlink transmission.

In one embodiment, performing the operation comprises: in response to no overlapping between the downlink transmission and the uplink sub-band and in response to the downlink transmission being to overlap with the first uplink transmission in time domain, resolving a potential collision between the downlink transmission and the first uplink transmission.

In one embodiment, performing the operation comprises: in response to the downlink transmission being to overlap with the first uplink transmission in time domain, determining one of the first uplink transmission and the downlink transmission as a target transmission to resolve a potential collision between the first uplink transmission and the downlink transmission.

In one embodiment, the method as above further comprises: in response to no potential collision between the downlink transmission and the first uplink transmission and the downlink transmission being to at least partially overlap with the uplink sub-band, cancelling the downlink transmission: or transmitting part of the downlink transmission located in the downlink sub-band.

In one embodiment, the method as above further comprises: transmitting, to the terminal device, a third indication of a second uplink transmission to be transmitted by the terminal device in the uplink sub-band in the time interval associated with sub-band full duplex mode.

In one embodiment, the method as above further comprises: in response to the second uplink transmission being to overlap with the first uplink transmission in time domain, determining a target uplink transmission based on the first uplink transmission and the second uplink transmission to resolve a potential collision between the first uplink transmission and the second uplink transmission; and resolving a potential collision between the downlink transmission and the target uplink transmission.

In one embodiment, the target uplink transmission is one of: the first uplink transmission, the second uplink transmission, or an adjusted first uplink transmission determined by multiplexing a portion of the second uplink transmission in the first uplink transmission.

In one embodiment, performing the operation comprises: in response to the second uplink transmission being to overlap with the first uplink transmission in time domain, determining one of the first uplink transmission and the downlink transmission as a target transmission to resolve a potential collision between the first uplink transmission and the downlink transmission; and resolving a potential collision between the target transmission and the second uplink transmission.

In one embodiment, performing the operation comprises: in response to an overlapping between the downlink transmission and the first uplink transmission in time domain being earlier than an overlapping between the first and second uplink transmissions in time domain, determining one of the first uplink transmission and the downlink transmission as a target transmission to resolve a potential collision between the downlink transmission and the first uplink transmission; and in response to the overlapping between the first and second uplink transmissions in time domain being earlier than the overlapping between the downlink transmission and the first uplink transmission in time domain, determining a target uplink transmission based on the first uplink transmission and the second uplink transmission to resolve a potential collision between the first and second uplink transmissions.

In one embodiment, performing the operation comprises: in response to a common priority of the first and second uplink transmissions being lower than a priority of the downlink transmission, stopping receiving the first and second uplink transmissions; and in response to the priority of the downlink transmission being lower than the common priority of the first and second uplink transmissions, dropping the downlink transmission.

A terminal device comprises: a processor; and a memory coupled to the processor and storing instructions thereon, the instructions, when executed by the processor, causing the terminal device to perform acts comprising the method according to any of the above embodiments.

A network device comprising: a processor; and a memory coupled to the processor and storing instructions thereon, the instructions, when executed by the processor, causing the second network device to perform acts comprising the method according to any of the above embodiments.

A computer readable medium having instructions stored thereon, the instructions, when executed on at least one processor, causing the at least one processor to perform the method according to any of the above embodiments.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-24. (canceled)

25. A method, performed by a terminal device, the method comprising:
receiving, from a network device, a first indication on a set of transmissions in a set of time intervals, wherein a time interval in the set of time intervals is a sub-band full duplex symbol;
receiving, from the network device, a second indication, wherein whether the time interval is a valid time interval or an invalid time interval is determined based on the second indication; and
receiving or transmitting a transmission in the time interval among the set of transmissions, in response to determining that the time interval is the valid time interval,
not receiving or transmitting the transmission, in response to determining that the time interval is the invalid time interval.

26. The method of claim 25, wherein:
the second indication corresponds to a type of a time interval for a first transmission in the set of transmissions.

27. The method of claim 26, wherein:
the time interval is the valid time interval, in a case where the type of the time interval for the first transmission in the set of transmissions is a time interval associated with the sub-band full duplex mode.

28. A terminal device, comprising a processor configured to cause the terminal device to:
receive, from a network device, a first indication on a set of transmissions in a set of time intervals, wherein a time interval in the set of time intervals is a sub-band full duplex symbol;
receive, from the network device, a second indication, wherein whether the time interval is a valid time interval or an invalid time interval is determined based on the second indication; and
receive or transmit a transmission in the time interval among the set of transmissions, in response to determining that the time interval is the valid time interval,
not receive or transmit the transmission, in response to determining that the time interval is the invalid time interval.

29. The terminal device of claim 28, wherein:
the second indication corresponds to a type of a time interval for a first transmission in the set of transmissions.

30. The terminal device of claim 29, wherein:
the time interval is the valid time interval, in a case where the type of the time interval for the first transmission in the set of transmissions is a time interval associated with the sub-band full duplex mode.

31. A method, performed by a network device, the method comprising:
transmitting, to a terminal device, a first indication on a set of transmissions in a set of time intervals, wherein a time interval in the set of time intervals is a sub-band full duplex symbol;
transmitting, to the terminal device, a second indication, wherein whether the time interval is a valid time interval or an invalid time interval is determined based on the second indication; and
transmitting or receiving a transmission in the time interval among the set of transmissions, in response to determining that the time interval is the valid time interval,
not transmitting or receiving the transmission, in response to determining that the time interval is the invalid time interval.

32. The method of claim 31, wherein:
the second indication corresponds to a type of a time interval for a first transmission in the set of transmissions.

33. The method of claim 32, wherein:
the time interval is the valid time interval, in a case where the type of the time interval for the first transmission in the set of transmissions is a time interval associated with the sub-band full duplex mode.

34. A network device, comprising a processor configured to cause the network device to:
means for transmitting, to a terminal device, a first indication on a set of transmissions in a set of time intervals, wherein a time interval in the set of time intervals is a sub-band full duplex symbol;
means for transmitting, to the terminal device, a second indication, wherein whether the time interval is a valid time interval or an invalid time interval is determined based on the second indication; and
means for:
transmitting or receiving a transmission in the time interval among the set of transmissions, in response to determining that the time interval is the valid time interval,
not transmitting or receiving the transmission, in response to determining that the time interval is the invalid time interval.

35. The network device of claim 10, wherein:
the second indication corresponds to a type of a time interval for a first transmission in the set of transmissions.

36. The network device of claim 35, wherein:
the time interval is the valid time interval, in a case where the type of the time interval for the first transmission in the set of transmissions is a time interval associated with the sub-band full duplex mode.
